(19) United States
(12) Patent Application Publication
(10) Pub. No.: US 2014/0255812 A1
(43) Pub. Date: Sep. 11, 2014

(54) TAYLOR VORTEX FLOW ELECTROCHEMICAL CELLS UTILIZING PARTICULATE ELECTROLYTE SUSPENSIONS

(71) Applicant: Global Energy Science, LLC (A California Limited Liability Company), (US)

(72) Inventor: HALBERT FISCHEL, SANTA BARBARA, CA (US)

(73) Assignee: Global Energy Science, LLC (A California Limited Liability Company), Santa Barbara, CA (US)

(21) Appl. No.: 13/789,844

(22) Filed: Mar. 8, 2013

(51) Int. Cl. H01M 8/04; H01M 2/38

(52) U.S. Cl. CPC H01M 8/04291; H01M 2/38
USPC 429/451; 429/67; 429/51

(57) ABSTRACT

Taylor Vortex Flow galvanic electrochemical cells (100, 300, 500) such as batteries, flow cells and fuel cells for converting chemical energy into electrical energy and comprising a cylindrical spinning particulate filter (140, 230) between static cylindrical current collectors (106, 108) for use with electrolytes containing galvanic charge transfer particles (200, 242, 380, 420) functioning as numerous miniature electrodes and means for pumping electrolyte through the filter to produce accelerated reaction electrochemistry for higher cell power density are disclosed.

### CROSS-REFERENCE TO RELATED APPLICATIONS

This application is a continuation-in-part of U.S. Patent Application Ser. No. 61/717,589 of 25 Oct. 2013 that is a continuation-in-part of U.S. patent application Ser. No. 13/437,771 of 2 Apr. 2012 that is a continuation-in-part of U.S. patent application Ser. No. 13/235,480 of 18 Sep. 2011, now U.S. Pat. No. 8,187,737 of 29 May 2012 that is a continuation-in-part of U.S. patent application Ser. No. 13/194,049 of 29 Jul. 2011, now U.S. Pat. No. 8,283,062 of 9 Oct. 2012 that is a division of U.S. patent application Ser. No. 12/800,658 filed 20 May 2010, now U.S. Pat. No. 8,017,261 of 13 Sep. 2011, which claims the benefit of my U.S. Provisional Application No. 61/220,583 filed 26 Jun. 2009.

This application, identified as Case J, is related to the following patent applications of Halbert P. Fischel:
Case A: Electrochemical Cells Utilizing Taylor Vortex Flows, application Ser. No. 12/800,658 of 20 May 2010, now U.S. Pat. No. 8,017,261 of 13 Sep. 2011;
Case A1: Electrochemical Cells Utilizing Taylor Vortex Flows, application Ser. No. 13/194,049 of 29 Jul. 2011, now U.S. Pat. No. 8,283,062 of 9 Oct. 2012, which is a division of application Ser. No. 12/800,658 (Case A);
Case A2: Galvanic Electrochemical Cells Utilizing Taylor Vortex Flows, application Ser. No. 13/235,480 of 18 Sep. 2011, now U.S. Pat. No. 8,187,737 of 29 May 2012, which is a continuation-in-part of application Ser. No. 13/194,049 (Case A1), which is a division of application Ser. No. 12/800,658 (Case A), now U.S. Pat. No. 8,017,261 of 13 Sep. 2011;
Case B: Fuel Reformers Utilizing Taylor Vortex Flows, application Ser. No. 12/800,710 of 20 May 2010, now U.S. Pat. No. 8,187,560 of 29 May 2012;
Case C: Chemical Process Accelerator Systems Comprising Taylor Vortex Flows, application Ser. No. 12/800,657 of 20 May 2010, now U.S. Pat. No. 8,147,767 of 3 Apr. 2012;
Case D: Direct Reaction Fuel Cells Utilizing Taylor Vortex Flows, application Ser. No. 12/800,672 of 20 May 2010, now U.S. Pat. No. 7,972,747 of 5 Jul. 2011;
Case E: Dynamic Accelerated Reaction Batteries, application Ser. No. 12/800,709 of 20 May 2010 with Philip Michael Lubin and Daniel Timothy Lubin, now U.S. Pat. No. 7,964,301 of 21 Jun. 2011.
Case F1: Cross-Flow Electrochemical Batteries, application Ser. No. 13/171,080 of 28 Jun. 2011, now U.S. Pat. No. 8,158,277 of 17 Apr. 2012, claiming benefit of U.S. Provisional Patent Application No. 61/388,359 filed 30 Sep. 2010, and of International Patent Application No. PCT/US10/39885 filed 25 Jun. 2010, which is a continuation-in-part of U.S. patent application Ser. No. 12/800,658 (Case A now U.S. Pat. No. 8,017,261 of 13 Sep. 2011); Ser. No. 12/800,710 (Case B now U.S. Pat. No. 8,187,737 of 29 May 2012); Ser. No. 12/800,657 (Case C now U.S. Pat. No. 8,147,767 of 3 Apr. 2012); Ser. No. 12/800,672 (Case D now U.S. Pat. No. 7,972,747 of 5 Jul. 2011); and Ser. No. 12/800,709 (Case E now U.S. Pat. No. 7,964,301 of 21 Jun. 2011)—all filed on 20 May 2010;
Case G: Thick Electrode Direct Reaction Fuel Cells Utilizing Cross Flows and Taylor Vortex Flows, application Ser. No. 13/174,686 of 30 Jun. 2011, now U.S. Pat. No. 8,124,296 of 28 Feb. 2012;
Case H: Galvanic Electrochemical Cells For Generating Alternating Current Electricity, application Ser. No. 13/437,771 of 2 Apr. 2012 with Sheldon L. Epstein, now U.S. Pat. No. 8,394,518 of 12 Mar. 2013; and
Case I: Taylor Vortex Flow Cells Utilizing Electrolyte Suspensions, Application Ser. No. 61/717,589 of 25 Oct. 2012.
   The enumerated applications are incorporated herein by reference in their entirety.

### COMMON OWNERSHIP OF RELATED APPLICATIONS

Halbert Fischel is an inventor of all of the applications and patents enumerated above. All rights to this application and all of the enumerated applications and patents, including all of the inventions described and claimed in them, have been assigned to the same assignee of this application so that there was common ownership of all of these applications and patents at the time the invention described and claimed below was made.

### FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF INVENTION

1. Field of the Invention

This invention is in the field of galvanic cells such as batteries, flow cells and fuel cells used to convert chemical energy into electrical energy through use of galvanic or faradaic particles in electrolyte suspensions and having means to provide relative motion between a current collector and the electrolyte—including means for creating Taylor Vortex Flows (TVF) and Circular Couette Flows (CCF) in the electrolyte (U.S. Class 429/67; Int. Class H01M-2/38) to promote generation of electricity.

2. Description of Related Art

As described in Case H, two methods of converting chemical energy into electrical energy are a) burning fuel (e.g., coal, natural gas, fluid hydrocarbons) with oxygen to create heat in an engine used to provide mechanical power to an electrical generator or alternator and b) promoting a reduction-oxidation (redox) reaction in an electrochemical cell that generates an electrical current in a circuit external to the cell. The former method can provide direct current (DC) or alternating current (AC); however, the process is Carnot ΔT temperature-limited by materials and therefore efficiency of burning fuel for electrical energy is low in accordance with the Second Law of Thermodynamics. The second method is also constrained by the Second Law of Thermodynamics in that entropy change, TAS, at chemical and thermal equilibrium can approach the difference between H, enthalpy and G, Gibbs free energy and therefore can be highly efficient. This Specification describes novel electrochemical or galvanic cells for generating and utilizing chemical energy to provide electricity.

Galvanic cells produce electricity through spontaneous chemical reactions. Fuel cells are used to convert (e.g., oxidize) chemical energy stored in fluid fuels (generally containing hydrogen) into electrical energy through use of catalytic reactions that support physically-separated, reduction-oxidation (redox) chemical reactions. They are distinguished from faradaic cells (e.g., batteries and flow cells) that depend on faradaic reactions, which are redox reactions between distinct electropotential faradaic couples that, in some cases, can be electrically recharged; but, cannot react with hydrogen-based fuels. Galvanic cells are distinguished from electrolytic electrochemical cells that require an input of electrical energy to initiate and sustain electrochemical reactions (e.g., electrowinning), which are usually irreversible. Also, electrolytic cell electrodes do not contain catalytic or faradaic materials.

As used here, the term galvanic materials includes catalytic materials and faradaic materials. Catalytic materials support three-phase (catalyst—fuel or oxidizer—electrolyte) electrochemical redox reactions; but, the catalysts are not chemically altered as a result. Some examples include metals from Group 10 of The Periodic Table of the Elements, some alloys, such as Pt—Ru, and some molecules including a metal oxide, such as MnO₂. Faradaic materials support two-phase chemical reactions (metal—electrolyte) and are altered as a result. Some examples are as NiO(OH), Fe and Li.

In general, batteries (sometimes called cells or piles) and flow cells rely on two-phase (electrode-electrolyte) faradaic reactions where a pair of electrodes differing in electronegativity enters into a pair of reduction-oxidation (redox) reactions that separate or combine electrons from or to a metal. The electrons travel from one electrode to the other electrode through an external electrical circuit where work is performed while the ions travel through a fluid electrolyte between the electrodes.

In general, fuel cells exploit three-phase (catalyst—fluid—electrolyte) electrochemical reactions where the fluid is selected from a set consisting of fuel and oxidizer. These reactions separate electrons from atoms or molecules, which then become energized ions (e.g., protons, hydroxides). Like batteries and flow cells, the electrons travel from one electrode to the other electrode through an external electrical circuit where work is performed while the ions travel through a fluid electrolyte between the electrodes.

This invention focuses on four principal problems in engineering galvanic cells; namely, how to:
1. Separate current collecting functions from galvanic reactions so that current collectors and electrodes can be optimized;
2. Provide convection gradient flows for cations that need to move in one direction and anions that need to move in an opposite direction;
3. Make available a stoichiometric balance of cations to react with all available anions; and
4. Depolarize current collectors that have attached ions reducing their electropotentials.
   Solutions to each of these problems are necessary in order lower cell internal impedance and to increase cell power and energy densities.

Patent applications, publications and patents of Halbert Fischel enumerated above describe examples of galvanic cells with low internal impedance through use of fluid dynamics. Those cells include fuel cells that store chemical energy in their fuels, batteries that store chemical energy in their electrodes and flow cells that store chemical energy in their electrolyte(s).

### GENERAL DESCRIPTION OF THE INVENTION

Cases A, A1, A2, D, E, G and H teach the use of TVF and CCF to improve the performance of fuel cells, batteries and flow cells incorporating a single electrolyte or two dissimilar electrolytes together with electrodes containing faradaic or catalyst particles or current collectors that do not contain any galvanic materials. Additionally, spinning liquid filter-generated TVF (also known as Taylor—Couette Flows) enhance reaction rates in electrochemical cells by a) reducing mass-transport losses, b) reducing charge transfer impedance, c) depolarizing current collector surfaces, d) preventing fuel and oxidizer or catholyte and anolyte crossover, e) capturing reaction products that can degrade catalysts, electrodes and electrolytes, f) eliminating those degrading reaction products from the cells, g) increasing temperature to reduce electrode overpotentials and raise reaction rates, h) permitting higher pressures and concentrations to accelerate reactions at both electrodes, i) enabling a new and unique application of lithium-ion chemistry and j) accelerating chemical reaction kinetics through use of forced convective electrolyte flow and TVF filtering.

TVF has a unique property of keeping distinct galvanic specie (both solids and gasses) separated while promoting the passage of ions solvated in liquids. Solid particles having masses (or densities) and sizes below a threshold remain trapped in a vortex. The same is true for gasses, which are trapped as bubbles.

Particles that have masses (or densities) at or above a threshold will be ejected from the vortex and can contact metal current collecting surfaces. If the particles have a charge, then the charge can transfer to the contact metal current collecting surfaces.

Fluid electrolyte TVF/CCF at current collector surfaces can form high-shear-rate convection gradient flows. Electrolytes moving rapidly across the current collector surfaces can depolarize surface potentials by removing redox reaction products that would otherwise accumulate on the current collecting surfaces to block further chemical reactions. Rapidly spinning TVF vortices literally scour polarizing ions off of the current collector surfaces so that currents can continue to flow.

Prior art batteries generally lack strong convection gradient flows that could clean the current collector surfaces and maintain current levels. Discharging conventional batteries are generally limited to diffusion and concentration gradient flows of electrolyte cations to depolarize the positive cathode surface and anions to depolarize the negative anode surface. The reverse applies to the charging cycle. For these reasons, current levels decrease with time and usage.

The spinning filters used here are preferably porous to electrolyte fluid flows—as distinguished from most membranes that permit ion-exchange; but, are impervious or highly resistant to fluid flows. Where the electrolyte TVF flows are generated by a spinning filter, the fluid dynamics associated with the spinning filter will keep particles from reaching and penetrating the filter. Thus, TVF can keep incompatible components isolated and eliminate any need for semipermeable membrane separators that increase internal impedance in conventional cells. Case A provides a description of TVF.

This invention is a class of TVF galvanic electrochemical cells (e.g., Case A2 and Case H) with improved electrolytes containing suspensions of Plowable galvanic particles that serve as numerous miniature electrodes. These are particles that are free to move within the suspensions—as distinguished from stationary galvanic particles that are fixed to an electrode or otherwise unable to move. The use of the suspended particles that operate independently of current collectors permits optimization of both the particles and the current collectors.

An important concept of this invention is the novel use of fluid dynamics in galvanic (as distinguished from electrolytic) cells for converting chemical energy into electrical energy. As described below, conventional battery cells and flow cells not utilizing TVF; but, comprising electrolytes containing a variety of suspended particles, are known in the art. One reason that TVF galvanic cells of this invention can outperform conventional galvanic cells is that TVF galvanic cells are configured to optimize their electrolyte fluid dynamics in order to improve how particulate suspensions interact with current collectors in electrolyte chambers.

The embodiments to be described below are improvements over teachings in Case A2, Case H and prior art. In this invention, the electrically-conducting component structure containing galvanic material is divided into small particles—each resembling a small element of the typical galvanic active structure. These particles are called charge transfer particles (CTP). The CTP are mixed with the electrolyte (e.g., KOH) to form a suspension, which may be a non-Newtonian (e.g., thixotropic) fluid.

Thixotropy is the property of certain non-Newtonian fluids that are thick or viscous under normal conditions; but, become less viscous over time when shaken, agitated, spun in TVF or otherwise stressed. They then take a fixed time to return to a more viscous state. Newtonian fluids (e.g., aqueous KOH as used in prior art fuel cells and batteries) exhibit linear relationships that converge at zero shear stress and shear rate. By contrast, a thixotropic fluid (e.g., aqueous KOH containing suspended CTP) is a non-Newtonian fluid that requires a finite time to attain equilibrium viscosity or shear stress when introduced to a step change in shear rate.

The principal function of CTP is to transfer electrical charge to or from a current collector when the CTP collide with a current collector that is connected to an electrical circuit. The CTP must have an attribute of sufficient:
a) mass so that centrifugal force will cause them to escape from the Taylor vortex with sufficient kinetic energy so that they will impact the current collector with enough momentum and contact pressure to cause transfer of charges between the current collector and the CTP; and
b) size so that the pressure of shear forces adjacent the current collectors will cause losses of angular momenta and drive CTP back into the Taylor vortex after contact with the current collector; and
c) volumetric particle concentration in the electrolyte so that frequent inter-particle collision maintains an approximately uniform particle suspension.
   These characteristics are common to all classes of CTP.

There are four classes of CTP; namely:
1. hammers that are galvanically-inert materials working in combination with galvanic particles lacking sufficient mass or size to be CTP;
2. faradaic anolyte CTP;
3. faradaic catholyte CTP; and
4. catalytic CTP—both anolyte (fuel oxidizing) and catholyte (oxygen reducing).
   All classes of CTP are foci of electric charges. Therefore, the CTP must be compatible with galvanic reactions that are on or near them. The CTP also must be capable of enabling charge transfers with the current collector.

Hammers are not capable of acquiring charges through galvanic reactions by themselves. Typically they are hydrophilic particles that are combined with supplementary particles that can be charged by galvanic reactions; but, lack either the mass or the size need to qualify as CTP. The supplementary particles can be attached to the hammers (e.g., plated) or they can be attracted to the hammers (e.g., by wetting). The hammers are vehicles used to transport the supplementary particles from the Taylor vortex to the current collector and force the supplementary particles against the current collector with sufficient pressure to cause charge transfer. The hammers can be solid or porous metal particles. Porous metal is preferred if the pores contain the supplementary particles and the supplementary particles can be wetted by electrolyte.

The faradaic anolyte CTP are metal (other than Group I) or metal hydrides (MH). They typically comprise porous metal powders throughout their structures that have been sintered to about 50 to 60% density.

The faradaic catholyte CTP are used in either aqueous or aprotic electrolyte suspensions. The aqueous electrolyte version may comprise NiO(OH). Pure NiO(OH) is a fine powder that does not easily form into large porous structures through sintering or other processes. NiO(OH) can be used by chemically depositing it into interior surfaces of a micro or nano-porous nickel olivine substrate. Such structures are described in the literature as electrodes. Here, NiO(OH) and its nickel olivine substrate is converted to CTP by breaking the electrode into appropriate mass and size particles. Similarly, for anodic lithium metal, glassy (nano-porous) carbon can be deposited onto an olivine copper structure as intercalation material. Aprotic catholyte CTP can be manufactured from sintered spinels in the form of fine powder that can be further sintered into larger porous electrolyte-wettable particles of appropriate mass and size.

The catalytic CTP can be either coated hammers or, preferably, the porous electrode structures described above as made from olivine substrates. For both alternatives, their metal surfaces are coated with graphene forms of carbon that are substrates for catalyst particles. The only difference between anolyte and catholyte catalytic CTP are the catalyst particles used to either promote the reduction of oxygen (catholyte) or oxidation of fuel (anolyte).

Novel configurations of galvanic cells of this invention generate dynamic forces in the fluid that accelerate CTP in the electrolyte suspension to make low-electrical-impedance, brief contact with the cell's current collectors. At any given instant, there are some CTP approaching the current collectors, some in contact with the current collectors and some departing from the current collectors. Not all CTP are in contact with the current collectors to participate in the current-producing reaction at a given moment; but, those that have been charged and make momentary contact with the current collector surface contribute to the cell's electrical current. Novel structures are provided to assure that population and frequency of such contact is sufficient to support high current, power and energy densities.

Some prior art secondary storage cells and some fuel cells utilize laminar electrolyte flows to generate convection gradients in electrolytes that cause Newtonian fluid velocity vectors, both parallel and normal to current collector surfaces, electrodes and their adjacent Helmholtz layers, to approach zero. Prior art fuel cells do not use electrolyte particle suspensions. But for those battery cells and flow cells that do use electrolyte particle suspensions, both a) the number of collisions between suspended particles and adjacent current collectors and b) particle collision momenta are limited by a lack of strong fluid velocity vectors normal to the collector plates. This is one reason that current density in conventional cells is limited to low values (e.g., <0.5-Amperes per cm² of collector or electrode projected surface area at 1 volt). A number of techniques attempt to address this limitation.

Standard art battery architecture incorporates faradaic material in a thin paste wrapped under pressure or compressed into a porous cake or briquette where faradaic material is physically attached to metal current collectors or electrodes. A conducting additive (usually carbon) facilitates electrical conduction between finely divided faradaic particles. Another architecture comprises faradaic particles physically attached to porous electrode scaffolding. In all these prior art architectures, a good stable electrical conduction path from the faradaic particle to the metal current collector is sought.

Faradaic particles in so-called semi-solid electrochemically active suspensions of prior art faradaic battery cells cannot, because of their very nature, provide a good electrical conduction path to electrodes, efficient ion mass transport between electrodes, or efficient removal (depolarization) of redox products from electrode surfaces. In the prior art cells, both charging and discharging current densities are limited by mutual ionic cross-diffusion between polar electrodes. Galvanic particle electrolyte suspensions containing catalyst have not been found in fuel cells.

For example, U.S. Pat. No. 4,126,733 of 21 Nov. 1978 to Doniat teaches a faradaic battery cell incorporating an electrolyte containing low-density glass or plastic balls that are coated with zinc and have diameters in the range of 0.2 to 2.0-mm. While not expressly taught by Doniat, electrolyte suspension flow through the anode electrolyte chamber would have to be laminar (not turbulent) in order to limit pump power loss. Therefore, a particle velocity vector normal to the collector surface must approach zero for laminar flow, which means that current density must be low. Additionally, use of low-density balls that reduce particle collision momenta further reduces current density

Doniat's '733 battery patent seeks to overcome low current density limitations by teaching Advantageously, the transverse dimension of the compartment A (anode electrolyte particulate suspension chamber) is small in order to authorize as many impacts of the (low density) balls 18 on the (current) collector 14, for the sake of obtaining a yield of electrochemical oxidation as high as possible. However, reduction of the transverse dimension of the anode compartment reduces the number of balls available to complete a galvanic reaction and this also limits current density.

Further, narrowing a compartment while maintaining the pumping rate increases the shear rate in the compartment's electrolyte. This increases power requirements for pumping and therefore decreases net power available to a load.

A second example of a battery cell incorporating electrolyte with suspended particles is taught by Chiang et al in Patent Publication No. US2010/0047671 of 25 Feb. 2010 for a High Energy Density Redox Flow Device. Chiang et al teach faradaic cells employing fine particles of 2.5-to-10-micron suspended in electrolytes—such as slurries, particle suspensions, colloidal suspensions (sols), emulsions, gels, or micelles where particles suspended in electrolyte act as electrodes that participate in faradaic redox reactions adjacent to non-reactive current collectors.

Chiang et al also teach:
In some embodiments, the rate of charge or discharge of the redox flow battery is increased by adjusting the interparticle interactions or colloid chemistry of the semisolid to increase particle contact and the formation of percolating networks of the ion-storage material particles. In some embodiments, the percolating networks are formed in the vicinity of the current collectors. In some embodiments, the semi-solid is shear-thinning so that it flows more easily where desired. In some embodiments, the semi-solid is shear thickening, for example so that it forms percolating networks at high shear rates such as those encountered in the vicinity of the current collector.

A liquid that is percolating is, by definition, moving slowly or gradually—especially as compared to a liquid in a TVF cell (e.g., Case A2, Case H) that is propelled by convective flow. When compared with TVF cells, entrained particles of Chiang et al in percolating liquids have much lower momenta and those momenta vectors are mainly parallel to the surfaces of the current collectors. Therefore, a particle in percolating flow has a velocity vector component orthogonal to the collector surface that must approach zero, which means that current density must be low—on the order of a few milliamperes per square centimeter of projected current collector area.

Solid particles in suspension tend to avoid contact with stationary containment surfaces for two reasons. First, suspended particles are wetted and sheathed by a significant thickness of insulating fluid. Second, the flowing suspension creates a shear boundary layer that inhibits particle contact with the containment surfaces. For these reasons, there is only a modest electrical connection of suspended particles to the containment surface and negligible current density is a result.

Moving metal current collector devices (beaters, pump vanes, etc.) have been used. Moving metal surfaces may make contact with particles but they are not suitable as current collectors because charge transfer through slip rings, commutators or brushes to fixed terminals is very lossy at high current density. TVF cells of this invention comprise stationary current collectors and rely upon moving suspended galvanic particles that make contact with sufficient force and conductivity to initiate redox reactions and generate high current density.

Chiang et al teach additional battery cells incorporating fine, micron-sized particles suspended electrolytes in Patent Publication No. US2012/0164499 of 28 Jun. 2012 for a Stationary, Fluid Redox Electrode. These particles have sizes ranging from 10-microns to less than 1-micron. Other references to similar battery cells include Patent Publication No. US2011/0189520 of 4 Aug. 2011 to Carter et al for a High Energy Density Redox Flow Device (2.5-to-10-micron particles); Patent Publication No. US2011/0200848 of 18 Aug. 2011 to Chiang et al for a High Energy Density Redox Flow Device (2.5-to-10-micron particles); Patent Publication No. US2011/0274948 of 10 Nov. 2011 to Duduta et al an Energy Transfer Using Electrochemically Isolated Fluids (2.5-to-10-micron particles) and Duduta et al, Semi-Solid Lithium Rechargeable Flow Battery, Advanced Energy Materials (20 May 2011), Vol. 1, pp. 511-516 (nanoparticles and micrometer-scale particles). Chiang et al is an inventor or author with others of each of these references. None of these references teach entrained particle momenta vectors that are orthogonal to current collector surfaces.

Percolating flows and other convection flows taught by Chiang et al create laminar boundary layers at current collector surfaces. The resulting shear forces are parallel to the current collector surfaces and these shear forces push the entrained particles away from the current collector faces. For that reason, finely divided particle (e.g., 2.5-to-10-micron particles) collisions with the current collectors and consequent ion transfer across a cell do not occur in sufficient numbers to support high current density.

As will be described below, TVF cells of this invention do not use fine particles in suspension; but instead, contain bigger particles (e.g., sintered porous aggregates of fine particles) having greater net densities than the particles taught by Chiang et al. Therefore, these particles, which are CTP, can be launched with greater energy available to penetrate laminar flows created by CCF at the current collector surface.

When a CTP suspended in electrolyte collides with the current collector and electrical contact is made, then the charge is transferred and the particle's attributes change from more-or-less dense to less-or-more dense as its composition changes (e.g., ZnCl²⇄Zn²⁺+2Cl). Size, shape and other attributes may also change.

For example, a β-NiO(OH) particle (density of 4.68 g/cm³) colliding with a current collector in a discharging alkali-electrolyte cell will release protons (H⁺) and undergo crystalline realignment to become a β-Ni(OH)₂ particle (density of 3.97 g/cm³), which differs not only in density; but also, the amount of intercalated water. Charge/discharge recycling can convert a portion of α- and β-Ni(OH)₂ precipitate particles to the γ form that has a significantly larger crystal structure. The γ-Ni(OH)₂ crystal structure is a serious problem for static cell packaging as the precipitate particle volume increase causes pressure to build within the cells. Such total suspension volume changes are easily accommodated in the TVF cell Balance of Plant (BOP) circulation of catholyte when the Ni(OH)₂ particles transform into a different species. Fluid dynamics have little effect on these species transformations in conventional galvanic cells, such as the Chiang et al cells; however, consequences are different in TVF galvanic cells.

Once a particle in a TVF cell transforms into a different species after collision with a current collector, it will be drawn back into the TVF because of vortex fluid dynamics and because of its change of momentum upon collision with the current collector. Upon return to the TVF, the particle is available for repeated charge or discharge. This particle species feature discrimination cannot be exploited in the Chiang et al galvanic cells that rely on laminar flow because particles in a flow stream near the current collectors will remain near the current collector. Further, recently discharged particles impede approaching charged particles from contacting the current collector.

Chiang et al teach that this limitation at the surfaces of the current collectors can be overcome by vigorous mechanical stirring. However, mechanical stirring of a suspension contained within vessel walls creates a tangential shearing boundary layer of nearly pure electrolyte adjacent the current collector surfaces. This boundary layer will cause an anisotropic suspension of particles (especially very small particles surrounded by a film of attached electrolyte) to avoid the current collector.

Chiang et al also teach that heating and cooling will produce convective vortices rising normally from cell walls in accordance with the Rayleigh-Bénard theory of vortex flows; however, these flows will drive particles away from, not toward, the current collector surfaces because they also create current collector surface boundary layers. Percolation from a current collector will produce the same result.

Current density is related to the numbers of suspended particles (e.g., CTP) that are displaced from near the current collectors after collisions. However, there is less particle kinetic energy available in a Chiang et al cell from Rayleigh-Bénard vortex flows or percolation flows to move the transformed particles away from the current collector and expose its surface to approaching particles than is the case for stirring.

Stirring, which occurs in both Chiang et al cells and TVF cells, has different consequences in each type of cell. In Chiang et al cells, stirring of fine particle suspensions would provide a modest improvement; however, is does not solve the problem of particle depletion caused by laminar boundary flow in proximity to current collector surfaces. Roughening current collector surfaces would increase particle collisions; but, it would not supply sufficient energy that is needed to establish good electrical connections between the particles and the current collector surfaces. Thus, the current density will be lower in the Chiang et al cells than in TVF cells of this invention because there are fewer particle collisions having good electrical connections with current collectors per units of time and surface area in a Chiang et al cell than in a TVF cell.

Ten-micron and smaller particles in suspension as taught by Chiang et al offer no advantage to TVF cells because these particles would remain trapped within vortices and rarely collide with current collectors. Particles for use in TVF cells of this invention have different sizes, shapes and density ratios with respect to the suspending fluid and net mass so that they will not have any stable position within a TVF vortex.

Nano-size particles can be used in TVF providing they are accompanied by large metal conducting particles. These large metal hydrophilic particles, coated with an electrolyte suspension containing fine galvanic particles, act as hammers that drive the galvanic particles into a current collector. A better particle suspension alternative comprises finely divided nano-size faradaic or galvanic particles attached to the large micron-size metal particles.

After particles collide with the current collector surface and electrical charges are transferred, ions (e.g., K⁺, OH⁻, Li⁺) are released into the electrolyte solution. In the case of Chiang et al cells, ions move slowly along paths orthogonal to the current collector surfaces toward the opposite current collector. Only small diffusion, concentration and migration gradient forces slowly propel these ions through the electrolyte to complete the cell's internal chemical circuit. If electrolyte is pumped through the cell, then the ions must move across the cell along paths that are orthogonal to electrolyte convection flows, which do not provide any acceleration to the ions toward an opposing electrode.

By contrast, ion movement in TVF cells, such as those taught in Case A2, is very rapid because of convection currents. The ions are sequestered by high-shear-rate convection gradient forces generated by TVF that rapidly accelerate the ions from the current collector surfaces (depolarization) toward the rotating filter of Case A2 cells. Once at the filter, the ions can pass through the filter because they are solvated and enter the TVF on the opposite side for transport to the opposite current collector or they can combine with other ions near the filter to produce a reaction product (e.g., H₂O or alkali) in the electrolyte.

An extremely powerful CCF fluid boundary layer adjacent the rotating filter prevents pore clogging or penetration by suspended particles. Gaseous reaction products and unprocessed fuel or oxidizer remain trapped within TVF vortex centers that move axially toward an exit to BOP.

TVF cells have unique flow properties that are exploited to increase mechanical forces that aid in charge transfer by particles not taught in the prior art for use in galvanic cells. As described above, the Chiang et al particles flow tangentially past the current collector as an isotropic suspension. This can also occur in a TVF vector field. However, if a particle has particular size, shape, mass and density ratio with respect to its suspending fluid, then it will not have a stable position within a TVF vortex and will be thrust radially (not axially as in a Chiang et al cell) toward a collision with a current collector.

When comparatively large massive particles entrained within TVF circulation reach the periphery of a vortex, the particles have attained sufficient angular momentum to escape the vortex along a radial trajectory and be launched with considerable kinetic force against the current collector surface. If the particle is charged, then the collision of a particle with the current collector surface—especially a roughened surface—will cause the particle to transfer charge to the current collector, change species, instantly lose angular momentum and then be drawn back into the vortex. This sequence of events occurs in a rapid repetitive cycle.

If the Chiang et al suspensions of finely divided faradaic particles in liquid electrolyte are to be used in a TVF galvanic cell, then they require an addition of larger conducting particles acting as hammers in order to effectively transfer charges to the TVF current collectors. These larger particles must be of a volume fraction that would not excessively displace the faradaic or galvanic material.

For example, consider Ni or stainless steel (SS) particles having an enclosing sphere diameter in the range of 75 to 130-micron (75-130 μm) that is 7.5 to 13-times the diameter of the Chiang et al particles) for use in a TVF cell having a 1 to 2-mm gap and spinning at 3600-RPM. These larger particles will have a mass of ≈4 to 20×10⁻⁶-grams depending upon shape selected from a range extending from spherical to flake. Their forces at impact can be estimated. For smaller diameter filters, narrower gaps and higher rotational speeds; particle sizes in the range 30-75 microns and masses in the range or 0.5-1.0×10⁻⁶ grams are useful.

An impulse, J=∫ₜ_{₁}^{t}^{₂}mdv=∫ₜ_{₁}^{t}^{₂}Fdt,=F_{avg}(t₂−t₁) of a particle upon striking a current collector is due to a loss of virtually all of its angular momentum in the range of J=(mΔv−0) where Δv is approximately 600 cm/sec for a 1″ diameter filter rotating at 3600 rpm. Peripheral TVF vortex speed closely approximates the filter surface speed. For any gap width in the range of 1 to 2-mm, Δ(mv) will be in the range of 3.2 to 16×10⁻³-gm-cm/sec.

An important parameter is the interval of action, Δt=t₂−t₁. A particle moving at 600-cm/sec. at the periphery of the vortex can travel about 0.005 to 0.01-mm (the thickness of the CCF boundary layer) before surrendering its momentum to the current collector. The impulse interval is thus about 1.25 to 6.25-μsec for 1 to 2-mm gaps, respectively. The actual interval, based upon torque calculations, which are more accurate, is shorter. Consequently, a conservative estimate of the impulse (taken over a 1×10⁻⁵ second interval) in terms of force transfer is F_{avg}=240 to 1,200-gm-cm/sec² (dynes)=5.4×10⁻⁴ to 2.7×10⁻³-lbs. of force.

The size and shape of the particle limits the contact area to about a 25-micron radius circle for a contact area of 76×10⁻⁸ square inches, assuming some particle deformation at contact with a suitably roughened surface. Therefore, the contact pressure is greater than 690-psi (47-atm) and less than 3,450-psi (235-atm) for TVF gaps in the range of 1 to 2-mm and 3600-RPM. That pressure is both far greater than the contact pressure attainable with the Chiang et al 10-micron or smaller, fine particles and more than adequate to secure complete charge transfer. It is also sufficient pressure to cause particle deformation, which will lower the contact pressure while increasing the contact area between the particle and the current collector surface. Increasing the contact area will lower the current density in the point of contact and thereby reduce I²R heating losses where the current collector has contact with the particle.

By contrast, prior art 1 to 10-micron or smaller galvanic particles have a mass of ≈4 to 20×10⁻⁸-grams, depending upon material and shape selected. Because of their small sizes, these particles are enclosed by surface layers of electrolyte that have relatively high surface tensions, so the particles remain in isotropic suspension or settle out very slowly.

Thorough stirring of these Chiang et al fine particle suspensions tends to sustain isotropic distributions of particles—except adjacent to electrode or current collector surfaces. For this reason, the particles will remain in laminar flows of conventional cells and rarely touch current collector surfaces to convert to other species. U.S. Pat. No. 7,252,898 of 7 Aug. 2007 to Markoski et al teaches that multi-stream laminar flow of two electrolytes over electrodes to form stratified layers that do not mix—even in the absence of a physical barrier. This inability to mix retards transverse particle movement needed for electric current generation in conventional cells.

In TVF cells, 10-micron and smaller fine particles would remain within the vortex in stable concentrations. The particles would rarely acquire sufficient angular momenta to escape the vortex, contact the current collector and contribute to the cell's electrical current. This is why 75 to 100-micron-size particles are needed to carry fine galvanic particles toward collisions with current collectors. This is stark contrast to the Chiang et al teaching at Paragraph [0032] of their '499 publication where they state: Furthermore, the electrode active materials do not include materials that are added to facilitate the transport of electrons from an electrode current collector to the electrode active material (i.e., additional materials that increase the electronic conductivity).

The prior art does not teach the importance of assuring low impedance charge transfer from galvanic particles or materials in suspension (often referred to as electrodes to be distinguished from suspending electrolyte) to current collectors. Perhaps, it is assumed that the contact of active material with current collector surfaces is sufficient to cause charge transfer when, in fact, such contact occurs with much lower force and frequency than in a TVF cell.

Chiang et al describe viscosity in relation to shear rate; but fail to state that the highest shear rate and lowest viscosity occurs at current collector boundary surfaces where the galvanic particle population is largely depleted. The low numbers of particles near the current collectors together with their parallel flow path vectors contribute to low numbers of particle contact with the current collector and limit current density. This is not what occurs in TVF cells of this invention.

Catalytic particles suspended in electrolyte have not been used in prior art fuel cells. There, catalytic materials are affixed to electrically-conducting structures (e.g., electrodes, current collectors) of finite dimensions.

In some fuel cells, the electrode structure is porous so that the amount of catalytic material per unit area of structure or electrolyte flow can be increased. Specific activity (SA) is the exchange-current density per unit area of available catalyst surface. Both the SA of the catalytic material in or on the electrically-conducting structure and the ion diffusion path length through electrolyte to the complementary electrode limit current and power density. This is true even though all spatially distributed catalytic material can participate in simultaneous redox reactions.

In prior art fuel cells, catalyst SA depends upon catalyst surface access to dissolved gas (e.g., fuel or oxidizer and redox reaction products) mass transport through a thin electrolyte layer. Catalyst porous substrates (e.g., carbon) are deliberately made to be hydrophobic (e.g., coated with PTFE) in order to promote gas access to the catalyst. Hydrophobicity limits the ability of the carbon substrate to participate in ion exchange current or capacitive charge storage. Liquid electrolyte or ionomer (e.g., from NAFION® membranes) must penetrate the porous substrate to provide an electrolyte coating to the catalyst surface for a redox reaction. Hydrophobic catalyst porous substrates severely limit the amount of active catalyst surface that can participate in a redox reaction.

In TVF cells of this invention, novel CTP carrying electrochemical potential energies move as functions of their size, mass and density in and through TVF electrolyte vortices. Those CTP can exploit unique properties of TVF fluid dynamics in order to attain numerous, rapid, repetitive and exceptionally low impedance momentary contacts with a current collector surfaces that initiate redox reactions yielding cell current densities, which are much higher than those of conventional cells.

It is therefore a first advantage of the present invention is the provision of galvanic TVF cells comprising CTP in electrolyte suspensions that are especially configured for use with TVF.

A second advantage of the present invention is the provision of galvanic cells that have their galvanic components (e.g., CTP) separated from their current collectors so that performance of each type of component can be optimized.

A third advantage of the present invention is the provision of galvanic cells that provide convection gradient flows for cations that need move in one direction and anions that need to move in an opposite direction.

A fourth advantage of the present invention is the provision of galvanic cells that make available a stoichiometric balance of cations to react with all available anions.

A fifth advantage of the present invention is the provision of galvanic cells that use fluid dynamics to depolarize current collectors that have attached ions reducing their electropotentials.

A sixth advantage of the present invention is the provision of TVF forced convective electrolyte flow that accelerates chemical reaction kinetics.

These advantages are more fully set forth in the following descriptions of preferred embodiments of this invention.

### BRIEF DESCRIPTIONS OF THE SEVERAL VIEWS OF THE DRAWINGS

FIG. 1 is a cross section drawing of a TVF flow battery of this invention.

FIG. 2A is a conceptual cross-section diagram of CTP moving through a discharging TVF Ni—Fe Cell.

FIG. 2B is a conceptual cross-section view of a CTP having a chemically inactive metal core and a low density metal cover.

FIG. 2C is a conceptual cross-section view of a CTP comprising micro- or nano-fine chemically active porous metal throughout its structure.

FIG. 3A is a cross section drawing of a TVF metal-air flow battery similar to that of FIG. 1; but, using oxygen gas in the oxygen reduction reaction (ORR) as its catholyte.

FIG. 3B is a conceptual cross-section view of a CTP having a chemically inactive metal core covered by carbon (e.g., porous nanoscale graphene structures) that supports dispersed catalyst nanoparticles, either for the oxygen reduction reaction, ORR or oxidation of fuel.

FIG. 4A is a conceptual cross-section view of a galvanic cell current collector pore and electrolyte meniscus taken from the prior art.

FIG. 4B is a conceptual cross-section view of a galvanic cell current collector pore and electrolyte meniscus of this invention.

FIG. 4C is a conceptual cross-section view of FIG. 4B at a moment when a CTP collides with the current collector.

FIG. 5 is a cross section drawing of a TVF fuel cell, which is similar in construction to the battery of FIG. 3A.

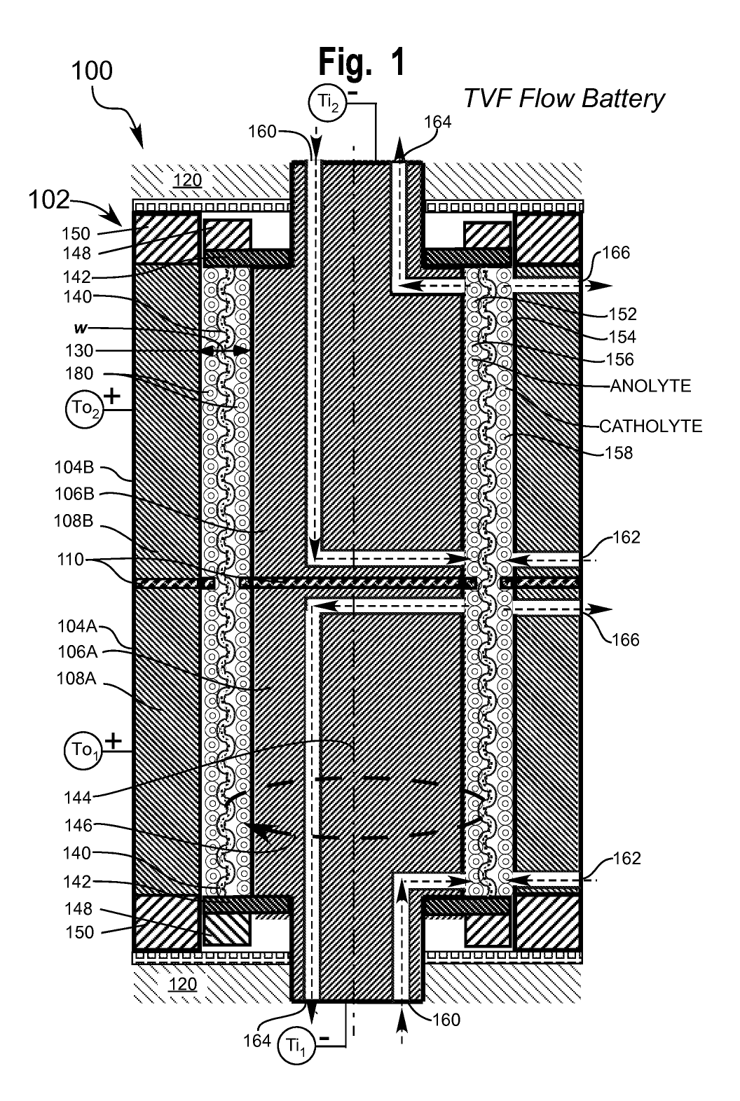

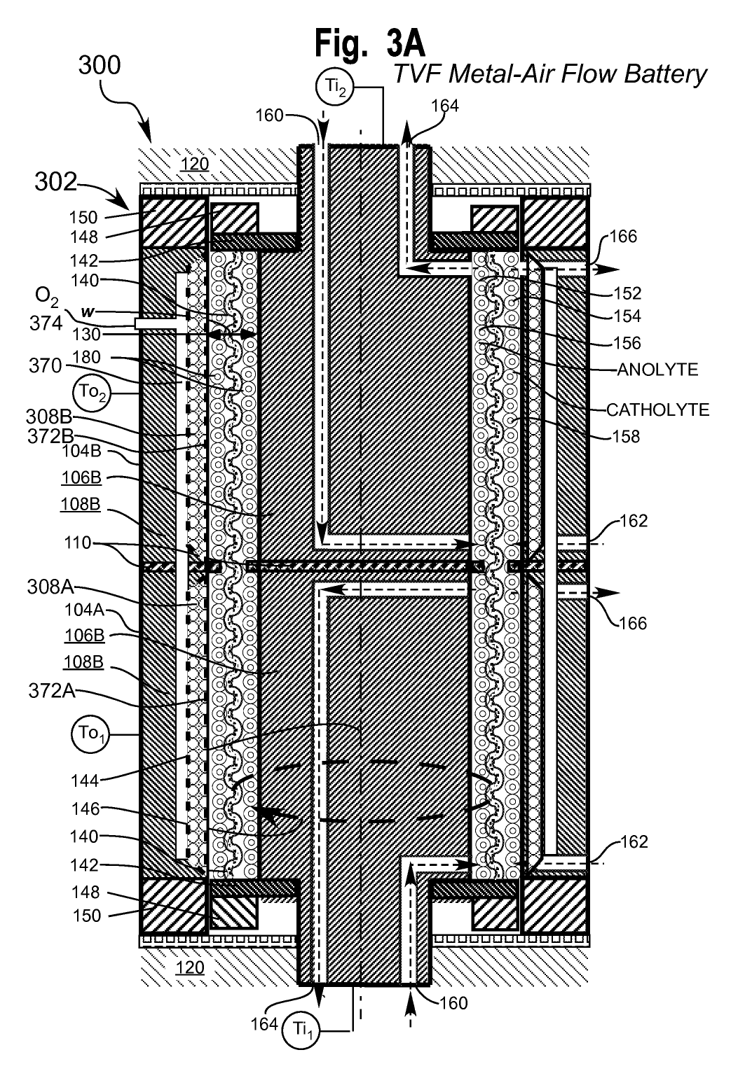

Because the TVF flow battery of FIG. 1, the TVF metal-air flow battery of FIG. 3A and the TVF fuel cell of FIG. 5 comprise the same or similar elements, the same reference numerals are used in all three FIGURES. All of the reference numerals consist of three digits. The most significant digit identifies the FIGURE where the corresponding element was introduced. Thus, the reference numeral “150” was first introduced in FIG. 1 and is associated with a motor stator. The same reference numeral also appears in FIG. 3A and FIG. 5 for each motor stator.

### DETAILED DESCRIPTION OF THE INVENTION

### The Flow Battery

FIG. 1 is a cross-sectional view of essential features of a preferred embodiment of an electrochemical cell 100 comprising a TVF flow battery 102. The flow cell 102 is similar to the flow cell 502 of Case A2, with some important improvements that are to be described.

The flow battery 102 comprises two flow cells 104A,B; however, it may contain any number of flow cells. The cells can be connected in series to obtain a higher battery voltage or in parallel to obtain a higher battery current.

Each of the flow cells 104A,B comprises first 106A,B and second 108A,B cylinder-like current collectors having terminals Ti_{1,2}, To_{1,2}. In this embodiment, the first current collector 106A,B is a negative inner cylindrical current collector that is connected to terminal Ti₁ or Ti₂ and the second current collector is a positive outer cylindrical current collector that is connected to terminal To₁ or To₂ as shown in FIG. 1. The terminals Ti₁, Ti₂, To₁, To₂ are used to connect the current collectors 106A,B and 108A,B to an electrical load (not shown in FIG. 1). In this embodiment, the current collectors do not have any galvanic function; that is, they do not participate in any faradaic or catalytic reactions.

The current collectors 106A,B and 108A,B are separated from each other by an electrical insulator 110 that mechanically secures them to each other. The current collectors 106A,B and 108A,B are static in this embodiment; that is, they are fixed to case 120 and do not rotate. The terminals Ti_{1,2} and To_{1,2} respectively could be called anode and cathode; however, these are current collector terminals—not electrode terminals because the current collectors of this embodiment do not participate in galvanic reactions that produce electricity. The polarity of Ti_{1,2} is minus (“−”) and the polarity of To_{1,2} is plus (“+”) in this embodiment. This nomenclature is used throughout because terminal polarities are dependent on chemistries used in a cell.

In this embodiment, the inner current collectors 106A,B form coaxial right-circular cylinders as shown in FIG. 1; however, this attribute is not a requirement and other cylinder-like geometries (e.g. elliptical, conical, hyperbolic, irregular, different axes) may be employed. The same is true for outer current collectors 108A,B.

The current collectors 106A and 108A and the current collectors 106B and 108B are separated from each other by a fluid electrolyte gap 130 having a width w. Surfaces of the current collectors 106A,B and 108A,B should be roughened metal, such as SS or SS coated with graphene or another active carbon, such as carbon nanotubes (CNT) or those used to construct supercapacitors. SS may be a thin layer deposited on copper or aluminum bulk metal for better electrical conduction.

A cylindrical spinning filter 140 mounted on sealed bearings 142 is journaled for rotation around the flow battery centerline 144 within the gap 130, as shown by arrow 146. Means for rotating the spinning filter 140 and the sealed bearings 142 comprise motor rotors 148 within motor stators 150. In this embodiment, the spinning filter 140 forms a coaxial right-circular cylinder as shown in FIG. 1; however, this attribute is not a requirement and other cylinder-like geometries (e.g. elliptical, conical, hyperbolic, irregular, different axes) may be employed. Also as shown in FIG. 1, the current collectors 106A,B and 108A,B and the spinning filter 140 are coaxial; however, this is not a requirement. The means for rotating the spinning filter 140 causes TVF and CCF 152, 154 to form in electrolyte in inner and outer electrolyte chambers 156, 158, respectively.

The gap 130 is filled with electrolyte. The electrolyte in the inner electrolyte chamber (156) contains a suspension of metal particles of a first type (not shown) and the electrolyte in the outer electrolyte chamber (158) contains a suspension of metal particles of a second type (not shown). These metal particles in electrolyte suspensions are CTP. These suspensions are an anolyte in the inner electrolyte chamber 152 and a catholyte in the outer electrolyte chamber 154 that are separated by the spinning filter 140; however, the positions of the anolyte and catholyte could be reversed in other embodiments. While each suspension contains CTP that is different from the CTP in the other suspension, both suspensions contain the same electrolyte. The faradaic metal comprising CTP in the catholyte is substantially more electronegative than the faradaic metal comprising CTP in the anolyte; thereby, creating a potential difference between the terminals Ti₁ and To₁, Ti₂ and To₂.

The liquid-phase, aqueous electrolytes may be an alkali selected from a group including of KOH, LiOH, NaOH or a blend of some or all of these. Aqueous electrolyte wetting, particle dispersion and electrolyte penetration of CTP aggregate (e.g., sintered) sub-micron particle interstices can be improved using many known liquid dispersants. Examples of additives for aqueous catholytes include sodium and potassium salts of HEDP with Co(OH)₂ as described in U.S. Pat. No. 4,940,553 of 10 Jul. 1990 to von Benda et al and Zn(OH)₂ and Ca(OH)₂ as described by Chen et al, Nickel Hydroxide as an Active Material for the Positive Electrode in Rechargeable Alkaline Batteries, Journal of the Electrochemical Society, 146(10) 3606-3612 (1999). Plated or graphite intercalated Li metal in aprotic electrolyte requires special provisions not covered in this embodiment.

The electrolyte may also be an aqueous acid providing that care is taken to prevent corrosion of the current collectors 106, 108. Some acids for consideration include HCl, H₂SO₄, H₃PO₄, HNO₃ or a blend of some or all of these.

In one example, anolyte is pumped into the inner electrolyte chamber 156 in the gap 130 between the filter 140 and the negative inner current collector 106A,B through anolyte entry ports 160. The catholyte is pumped into the outer electrolyte chamber 158 in the gap 130 between the filter 140 and the positive outer current collector 108A,B through catholyte entry ports 162. The electrolyte chambers 156, 158 for the anolyte and catholyte can be exchanged if the polarity of the flow battery 102 is reversed. Dotted-line arrows show the direction of anolyte and catholyte flow in the inner electrolyte chamber 156 and the outer electrolyte chamber 158, respectively.

The anolyte and catholyte are supplied from source tanks and spent tanks within a BOP (not shown). The BOP also contains particulate filters for collection of alkali or acid (depending on cell chemistry) from one of the chambers 156, 158 for use in the other of the chambers 158, 156. The tanks may be of a size necessary to support energy requirements of the flow battery 102 so that the size and mass of the flow battery 102 can be minimized because it need only contain sufficient amounts of electrolytes to meet its maximum power requirement. The anolyte and the catholyte leave the gap 130 through exit ports 164 and 166, respectively, for return to tanks in the BOP.

The anolyte flowing in the inner electrolyte chamber 156 comprises a mixture of an electrolyte such as KOH (an alkaline electrolyte) and anolyte CTP. Similarly, the catholyte flowing in the outer electrolyte chamber 158 comprises a mixture of the same electrolyte and catholyte CTP. The spinning filter 140 is porous to the electrolyte; but, impermeable to both types of CTP.

The anolyte CTP must range in size from about 30 μm to 130 μm (depending upon filter 140 radius and rotational rate) and in mass from 10⁻⁶ to 10⁻⁵ grams in order to escape TVF and make electrical contact with the inner current collectors 106A,B when the flow battery 102 is in operation. If the CTP are too small or have less mass, then they will not attain sufficient momenta for escape from the TVF and make solid electrical contact with the inner current collectors 106A,B when the flow battery 102 is in operation.

The catholyte CTP in alkali electrolyte can be fabricated from NiO(OH) powder of 1 to 5 μm dimension. For greater area dispersion, the molecule can be attached (e.g., grown) onto SS or porous Ni metal substrates in the form of nanoscale flake. The catholyte CTP can have a size and mass as stated above for the anolyte CTP. If the less expensive NiO(OH) powder form is used, then about 12% by volume of SS flake should be mixed with the powder so that the catholyte CTP will have at least the same size and mass as the anolyte CTP. Wetted SS flakes will carry NiO(OH) to the current collector 108 with sufficient force to make electrical contact.

The anolyte and the catholyte suspensions of faradaic particles have been referred to as ‘semi-solid’, non-Newtonian or thixotropic liquids. Their viscosities tend to be functions of shear strain imposed upon the mixture due to convective flow or flow within bounded surfaces.

The term, semi-solid generally applies to rheopectic liquid polymer formulations where viscosity increases with shear rate. Shear rate for faradaic suspensions described here cause a drop in viscosity with increasing shear rate. For purposes of TVF flow cells, the concentration of CTP in suspension is configured to meet specific objectives. Higher CTP concentrations contain and convert more chemical energy to electrical energy up to a maximum where an increase in viscosity reaches a point where TVF vortex flow cannot be sustained. Too low concentration reduces CTP interaction such as collision frequency. That limits the number of CTP flowing through the suspension needed to maintain an approximately uniform particle distribution and the number of collisions with current collector surfaces. CTP that, themselves, have the required size, density and mass stated above do not require fluid attachment to another particle, e.g., SS. Optimum concentration for such CTP is reached when the suspension has a kinematic viscosity, ν, of 10 to 100-centistokes, with a preferred range being from 20 to 40-centistokes. This is usually attained when the volumetric particle concentration of the charge transfer particles (156, 158) in the electrolyte is in a range between 40% to 75%, inclusive.

When the suspension contains fine faradaic powder, then it is important that the powder concentration be sufficient (50 to 65% by volume) to form a fluid coating of the fine particles on larger dense cores to form CTP. The CTP (SS or Ni) volumetric concentration should not exceed 20% and is best in the range of 5 to 12%. These CTP must be continuously circulated to avoid settling of the fine faradaic powders. The net suspension will again be adjusted to a kinematic viscosity, ν=μ/ρ of 10 to 100-centistokes with a preferred range being from 20 to 40-centistokes, where μ is dynamic viscosity in centipoise and ρ is fluid density.

The flow cell 102 is operated by pumping anolyte through inner electrolyte chamber 156, pumping catholyte through the outer catholyte chamber 158 and spinning the cylindrical filter 140 are a rate sufficient to generate the TVF 152,154 in both of the electrolyte chambers 156, 158, respectively. In this embodiment, the filter 140 is spun by energizing the motor stators 148 and rotors 150. Descriptions of TVF in galvanic electrochemical cells are found in Case A, Case A1, Case A2, Case D, Case E, Case G, Case H and Case I.

The catholyte and the anolyte CTP each serve as electrodes because the CTP comprise faradaic materials that are sites where two-phase redox reactions occur between the CTP surfaces and the electrolytes when the CTP contact the current collectors 106A,B and 108A,B. By separating the redox reactions of the CTP electrodes from fixed structural current collection architecture, the redox reaction process and the current collection functions, together with their supporting structures, can be optimized.

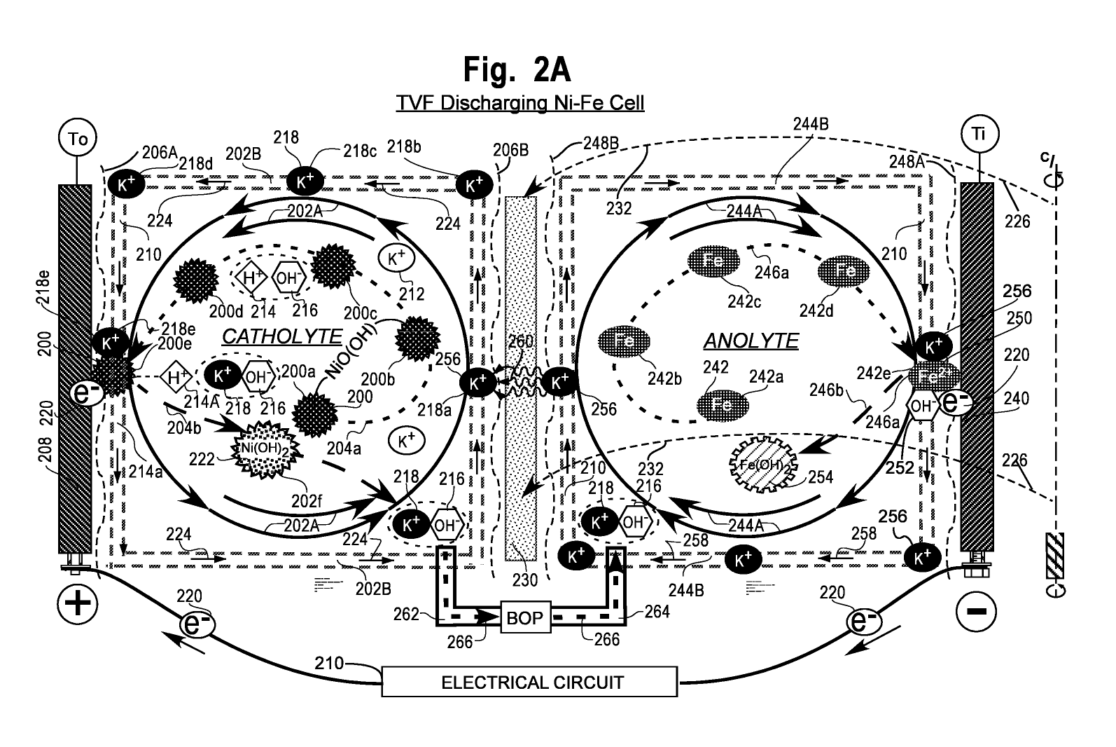

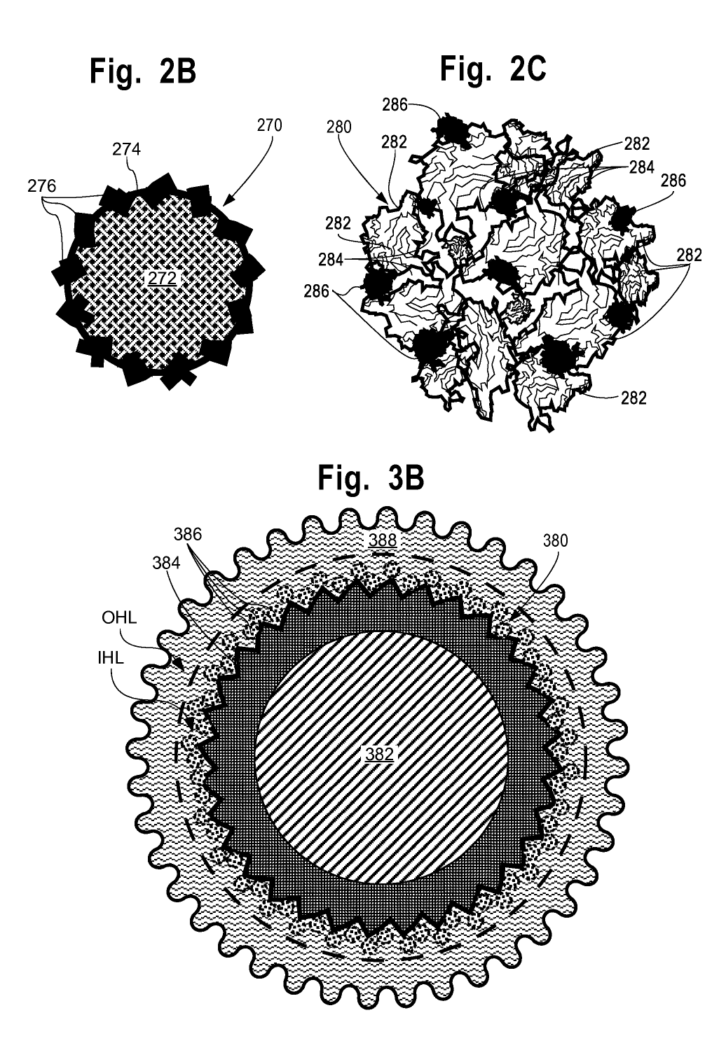

FIG. 2A is a conceptual drawings that illustrate how CTP and electrolyte flows create electrical current in an electrical circuit 210 for the discharging nickel-iron flow cells 104A,B of FIG. 1. This drawing may be better understood by viewing it in conjunction with FIG. 2D of the Case A patent drawings and an accompanying description that appears in the Specification of that patent (U.S. Pat. No. 8,017,261 of 13 Sep. 2011).

The half-cell reaction equations showing all constituents are:

in the catholyte:

2NiO(OH)+2(H⁺+OH⁻)+2K⁺+2e⁻ [symbol] 2Ni(OH)₂+2(K⁺+OH⁻)(+0.48 volt); Eq. (1)

and in the anolyte:

Fe+2(K⁺+OH⁻) [symbol] Fe(OH)₂+2K⁺+2e⁻(−0.89 volt) Eq. (2)

Discharging is read left-to-right, charging is read from right-to-left. While these reactions occur in both conventional Ni—Fe cells and Ni—Fe cells of this invention; there are structural and operational differences that are not readily apparent from the chemical formulae and produce substantially higher current densities in TVF cells 102 of this invention.

As described above, high current density requires depolarization of current collector surfaces in both prior art batteries and in TVF cells 100. To illustrate, Eq. (1) shows that cathode discharge requires adsorption of a hydrogen ion (from a water molecule) onto an electrode surface. In some prior art batteries with static combination current collectors that are also electrodes, the cathode surface becomes covered with unreactive and poorly conducting Ni(OH)₂ that lowers current density. In a TVF battery 102, the NiO(OH) CTP electron charge, e⁻, is transferred from the current collector 108A,B upon impact and the newly-formed Ni(OH)₂ particle is rapidly swept back into the TVF 154 so that it no longer is present at the current collector surface 108A,B.

The NiO(OH) CTP redox reaction leaves an OH⁻ anion free to accumulate on the positive cathode surface, which polarizes the cathode in the negative (or less positive) direction. In prior art batteries with combination current collector-electrodes, diffusion and concentration gradients of OH⁻ ions from a cathode surface are required to somewhat restore the cathode's electrochemical potential and allow electric current to flow. This is a slow process.

In the TVF battery 102, the high surface shear of TVF 154 accelerates the exchange of K⁺ and OH⁻ to depolarize the current collector 108 surface. An increase of K⁺ concentration in the catholyte due to cross spinning filter 140 flow from the anolyte, where a surplus of the cation is being produced, elevates the surface potential of the positive current collector surface 108 in the positive direction and helps to separate H⁺ from the water molecule. The same depolarizing effects operate at the negative current collector 106 surface as well as in the charging mode for both electrodes.

Eq. (2) does not disclose that it is not possible initially to provide a sufficient alkali electrolyte concentration in a conventional cell that can supply an amount of OH⁻ needed to fully convert (discharge) all of the Fe in the conventional cell's anode to Fe(OH)₂. Additional OH⁻ must be created in the catholyte and provided to the anolyte. This is especially true at a suitably high Fe particle concentration. For example, a typical 5-molar (23%) KOH anolyte suspension at 50% by volume concentration contains 0.0025 moles of H⁻ per ml of suspension. The other 50% is Fe as particles at an atomic weight of 56.845 and a density of 7.874 or 0.06926 moles per ml of suspension. The oxidation reaction requires 2 moles of alkali to process 1 mole of Fe so only 0.00125/0.06926=0.018 or 1.8% of the Fe can be discharged by the native alkali concentration.

If the cell reaction described in Eq. (2) is to continue past an initial depletion of OH⁻ ions, then the OH⁻ ions must be replenished. The only internal source of the OH⁻ ions is the catholyte—as shown in the right side of Eq. (1).

In prior art battery architecture with static components, the consumption of catholyte water on the left side of Eq. (1) substantially reduces the catholyte volume and creates an electrolyte convection flow from the anolyte to the catholyte. But, the OH⁻ ions need to move in the opposite direction from the catholyte to the anolyte and are driven only by concentration and related diffusion gradients, which must exceed in magnitude the opposing convection flow. The use in prior art (e.g., Chiang et al) flow cells of an ion-selective membrane (e.g., NAFION membrane) to keep anolyte and catholyte particles separated further restricts OH⁻ ion migration toward Fe reaction sites. All of these factors contribute to keeping current density low (e.g., <30-milliamperes/cm² of projected electrode area).

This is easily demonstrated by considering the following quantitative relationships with respect to current density, i, in amperes/cm². The water and opposing ionic molar flux=i/F where F is Faraday's constant=96,485. Molar flux can be related to an ionic velocity, v, in cm/sec. cv=i/F mole/cm²-sec. If c_{w} and cₐ are the molar concentrations of water and anion, respectively, and assuming the molar concentration of water to be somewhat less than 0.018 moles/ml and water volume to be on the order of 50%, then 0.009v≧i/F.

If υ_{d} is ion diffusion velocity with diffusion coefficient, D, then the anion molar flux is given by cₐD/d≦cₐυ_{d}. Diffusion velocity is independent of actual ion concentration, υ_{d}=D/d. Hence, (0.009)D/d≧i/F because its flux velocity must be greater than the opposing water convection. The value of D (see Bagotsky, page 61 and Newman, page 284, Table 11.1) for ion diffusion in aqueous electrolytes (except aprotic electrolytes used with Li metal) is uniformly about 10⁻⁵ cm²/sec. Therefore, i≦0.0087/d amps/cm².

If the total gap between electrodes in a typical prior art static cell is 0.25 cm, then the maximum possible current density is less than 35 milliamperes/cm². This is a fundamental limitation irrespective of the chemical kinetics at the electrodes, which can be further rate limiting. This analysis also assumes that there is no separator barrier that requires any faradaic material be immobilized by other means (e.g., porous scaffold, paste, briquette or other forms of fixation). In a prior art (e.g., Chiang et al) flow cell, water can be supplied by catholyte flow; but, there is no ion-selective membrane that can transmit anions (e.g., OH⁻) at appreciable rates.

Next, Eq. (1) shows that NiO(OH) will accept an electron (e⁻) and transform to Ni(OH)₂; but, NiO(OH) requires the addition of a proton (H⁺) to reduce the Ni⁺³ to Ni⁺² in order to accept the electron. However, protons must be extracted from the catholyte in the presence of OH⁻ ions that fundamentally suppress H⁺ ion concentration. Protons would become more plentiful and the cell would produce more current if the catholyte could have a low alkali concentration or if excess K⁺ cations from the right side of Eq. 2, created in the anolyte, could be conveyed to the reaction at the cathode current collector. Then, a proton will become available in the catholyte when a K⁺ or similar ion displaces a proton in a water molecule and forms a KOH or similar dipole. However, this does not happen with sufficient speed in prior art cells to produce high current densities.

In a KOH or similar electrolyte, K⁺ or similar ions are initially available in the catholyte; but, need to be replenished by K⁺ or similar ions from the anolyte. A problem in prior art batteries is that K⁺ or similar ion transport from the anolyte to the catholyte is slow and in an opposite direction from that of the OH⁻ ions; but, somewhat assisted by the electrolyte convection gradient. Nevertheless, the conventional cell current density will remain low because of a restricted supply of protons.

In prior art cells with static current collector-electrode configurations, their faradaic materials do not mix because of the cells' structural designs. The faradaic materials are held in electrodes and do not need any membrane to maintain their separation. Instead, porous separators are used to keep the electrodes from touching.

Common alkali (not acid) electrolytes are used for supplying cations and anions. These ions flow under diffusion gradients in opposite directions. The anolyte reaction runs because metal in an alkali is readily oxidized and because it is surrounded by OH— ions that leave excess cations (e.g., K⁺). The catholyte reaction runs when another metal (e.g., NiO(OH)) extracts a proton from water in the electrolyte. This step in the process is very slow unless there is a chemical or catalytic aid.

Eq. (1) and Eq. (2) do not provide reaction rates. They only illustrate reaction end points. It is true that OH⁻ anions diffuse toward the anolyte and K⁺ cations diffuse toward the catholyte; but, it is not true that they remain independent charges. In fact, the two ions form a KOH dipole that is charge neutral and move together in the electrolyte. But, the NiO(OH) requires a free proton (H⁺ ion) to oxidize into Ni(OH)₂ and there are relatively few free protons available, so the reaction runs slowly.

If, however, there are many more K⁺ ions than OH⁻ ions near or at the positive current collector surface 108A,B, then the reaction rate dramatically increases. The reason is that the K⁺ ions dissociate H⁺ ions from electrolyte water molecules, which increases their molarity and promotes surface adsorption of H⁺ ions. That accelerates the reduction of NiO(OH) into Ni(OH)₂, especially on the impact of CTP with the positive current collector surface 108A,B. In fact, this is what happens in the TVF flow battery 102.

Referring to the conceptual diagram of FIG. 2A, chemically-charged nickel-oxyhydroxide [NiO(OH)] catholyte CTP 200, having nickel in a +3 valance state, are suspended in aqueous electrolyte (e.g., KOH at low concentration, pH≧8) to form a catholyte. The catholyte CTP 200 initially is trapped near the swirling center of TVF 202A at position 200a because of momentary hydrodynamic forces exerted upon it by the electrolyte. In this disclosure (as distinguished from the Case A '261 patent), there is a central TVF 202A that is surrounded by a peripheral TVF 202B; however, they are only different regions of the same TVF that are introduced to aid in understanding how the reaction proceeds.

FIG. 2A should be studied in conjunction with FIGS. 2A, 2B, 2C and 2D and their accompanying descriptions beginning at column 9, line 17 of the Specification in the Case A '261 patent. The TVF 202A,B constitutes one of the several tori (50) shown in FIGS. 2A and 2B of the Case A '261 patent.

After the CTP 200 collides with another similar particle (not shown) and acquires some of the other particle's kinetic energy, the CTP 200 is accelerated along path 204a from position 200a to position 200b where centrifugal force and the velocity of the TVF 202 accelerate it to positions 200c and 200d before it penetrates at position 200e boundary layer shear stream CCF 206A and collides with positive current collector 208 that is connected to an electrical circuit 210

The CCF 206A corresponds to the CCF 58 of FIGS. 2C and 2D in the Case A '261 patent. As described in the Case A '261 patent at column 9, lines 36-46:
Of critical importance to the invention is the fact that the entire array of vortices 50 is enveloped by a high-shear-rate laminar boundary layer 58 (FIG. 2C and FIG. 2D) of spinning fluid almost fully covering each surface that encloses the array of vortices 50. Thin layers of fluid are moving with high laminar shear perpendicularly to the sectional plane of FIG. 2C. FIG. 2D provides a perspective view of the relationship between the CCF 58 and the TVF 50 rotating around the TVF axis 52. The CCF 58 are orthogonal to the TVF 50 and parallel to the TVF axis 52.
   The function of the CCF 206A will be more fully described after a description of a redox reaction at the current collector 208 and the current collector's connection to an electrical circuit 210.

The catholyte contains solvated K⁺ 212, H⁺ 214 and OH⁻ ions 216. The H⁺ 214 and the OH⁻ ions 216 are shown within a dotted ellipse because they are paired in dipoles to form water molecules. Similarly, there are some K⁺ 212 and OH⁻ ions 216 shown within a dotted ellipse because they are paired in dipoles to form electrolyte molecules. The catholyte also contains excess K⁺ ions 218 in TVF 202B that are not paired with OH⁻ ions 214.

If the electrical circuit 210 demands current, then the cathodic half-cell reaction in Eq. (1) proceeds when electrons (e⁻) 220 from the electrical circuit 210 flowing into the current collector 208 transfer their charges to the CTP 200 (giving it positive polarity as shown by an adjacent ‘+’ sign) at the position 200e where it has collided with the current collector 208. This collision and charge transfer simultaneously starts the cathodic reaction of the NiO(OH) CTP 200.

Because CTP 200 is fully wetted with catholyte and highly electrically conductive throughout its porous structure (e.g., by addition of cobalt oxides and hydroxides to the nickel oxide crystal structure), the cathodic reaction can occur at any point within the CTP 200 structure. As the electron 220 charge transfers to the CTP 200, the excess solvated K⁺ ions 218 in the catholyte attract and dissociate OH⁻ ions 216 from water molecules to form KOH dipoles, one of which has been shown enclosed in a dotted ellipse.

The excess solvated K⁺ ions 218 are necessary because they provide energy required to disassociate the H⁺ ions (protons) 214 from the water in the catholyte. This is a rate-determining step (RDS) that limits performance of prior art batteries because they lack a mechanism for providing excess solvated K⁺ ions 212 to the catholyte, especially at the cathode current collector surface 108A,B that is necessary for the next catholyte step.

In the next catholyte step, H⁺ ions 214A freed from their OH⁻ ions 214 in water molecules move to the charged NiO(OH) CTP 200 in contact with the current collector 208 (shown at the position 200e) as shown by the dotted line from a H⁺ ion 214A to the NiO(OH) CTP 200. H⁺ ions 214A now enter the charged NiO(OH) CTP 200 and cause a reduction in charge from +3 to +2 in the CTP 200 so that it becomes a Ni(OH)₂ particle 222. It is important to note that this reduction reaction would proceed very slowly without the excess solvated K⁺ ions 218 needed to liberate the disassociated hydrogen ions 214A.

The CTP 200 does not simply take the H⁺ ion 214A out of water to produce an OH⁻ ion 216 that circulates and finds a K⁺ ion 218 to form KOH. Iron, steel and ternary alloys containing Ni and Co can be used as roughened current collector 200 surfaces and somewhat effective catalysts for adsorption of the H⁺ ions from water; but, the CTP 200 does not readily extract H+ ions 214A directly from the current collector 208 surface without the help of K⁺ ion 218 to depolarize the current collector 208 surface (Bagotsky, page 271). Depolarization of the current collector 208 surface by K⁺ ions 218 is also aided by TVF 202B scrubbing action that moves the combined K⁺ and OH⁻ ions back toward the center of the gap 130.

In order to increase the reduction reaction rate of the CTP 200, the K⁺ ions 218 must be accelerated from the anolyte to the catholyte. For this reason, the anolyte is maintained at a higher pressure than the catholyte so that there always is a convection flow gradient from the anolyte to the catholyte through the spinning filter 230.

If Ż is the total volumetric cross-filter flow rate (ml/sec), A is the electrode area, i is the current density per cm² of electrode and c_{c} is the concentration (usually 5 molar) of alkali feeding the anolyte by way of a separate circuit through BOP, then c_{c}Ż=Ai/F and Ż/A=2.07×10⁻³·i ml/cm²-sec. If i=3 amps/cm², A=100 cm² and Ż=37.3 ml/min, then such a TVF cell 104AB provides the possibility of a TVF cell 100 current density that is 100 times greater than the current density of prior art galvanic cells.

As stated above, there always is a convection flow gradient from the anolyte to the catholyte through the spinning filter 230 so that the K⁺ ions 218 can reach the current collector 208 where they are needed to accelerate reduction reactions of the charged NiO(OH) CTP 200. However, there also is a very slight back-diffusion flow of ions from the catholyte toward the anolyte, which has a velocity of 10⁻⁵/0.025=4×10⁻⁴ cm/sec for a 0.025-cm-thick filter. This back-diffusion flow is negligible when compared with ion diffusion from the anolyte to the catholyte; where, for Ż/A=3.0 amp/cm², the K⁺ ion 218 diffusion velocity is 6.21×10⁻³ cm/sec or 15.5 times the back-diffusion velocity. For this reason, virtually all of the excess K⁺ cations 218 move from anolyte into catholyte.

Both the movement of the of K⁺ ions 218 and the decrease of H₂O cause the catholyte KOH concentration to increase. H₂O decreases because the H⁺ ions 214A are extracted from water and participate in the reduction reaction that forms Ni(OH)₂. That lowers the volume of water. In prior art batteries, reduction of the catholyte ions (e.g., Ni⁺³→Ni⁺²) only happens because of low diffusion and concentration gradients—not by convection. This is one important reason why prior art batteries are limited to relatively low currents when compared with TVF batteries 100.

In the example above, if Ai=300 amps and Vₘᵢₙ=the minimum suspension volumetric flow rate through the anolyte chamber at 50% liquid volume fraction, then 0.5VₘᵢₙΔc_{c}=Ai/F=3.11×10⁻³, where Δc_{c} represents the change in alkali concentration after passage through the anolyte chamber. Δc_{c}≅0.004, i.e., which does not exceed a concentration reduction from 5 molar to 1 molar. Thus, the minimum Fe anolyte flow rate, Vₘᵢₙ required to sustain 300 amps (at 3 amps/cm²) is 1.55 ml/sec. In typical TVF chamber designs, the gap width 130 is about 0.15 cm for a chamber volume of 15 ml. In the example, residence time for anolyte suspension is a maximum of 10 seconds.

It was shown that only a small fraction of the metal (1.8% Fe) can be discharged during a single pass through the cell because of its exceptional high energy density and practical limit on the concentration of native hydroxide OH⁻ ions. Therefore, the Fe CTP 242 anolyte suspension must be recirculated back to its BOP supply for repeated passage through the cell 104A,B to achieve substantial discharge of the Fe CTP 242.

It has also been shown that alkali OH⁻ ions 216 manufactured by the catholyte and needed by the anolyte for oxidation of the Fe CTP 242 do not pass through the spinning filter 230 because the electrolyte flow in the spinning filter 230 passes, by choice, from the anolyte to the catholyte. That is so that higher current density, i, can be attained and is only possible because of TVF filtration when flowing the electrolyte containing solvated excess K⁺ ions 256 manufactured in the anolyte during discharge through the spinning filter 230 from anolyte to catholyte at rate, Ż ml/sec.

The flow rate, Ż, is controlled and does not contain the CTP 242 as they are prevented from reaching the surface of the spinning filter 230 by action of the CCF 248B. Consequently, the Fe CTP 242 concentration and viscosity will increase during their passages through the cell 104AB. As a practical criterion it may be necessary to limit the particle fraction to 60% at the anolyte exit ports 164 to avoid excessive viscosity. Ż=Vᵢₙ−Vₒᵤₜ; where Vᵢₙ and Vₒᵤₜ are volumetric flows into and out of the anolyte chamber 152, respectively. Thus, for a Fe CTP 242 concentration change from 50% to 60%, Vᵢₙ=6Ż or 3.726 ml/sec in the example above. That is a factor of 2.4 times higher than Vₘᵢₙ in the example calculation above that is based upon maximum allowable alkali consumption. Thus, the residence time becomes 4-seconds rather than 10-seconds.

The catholyte remains in the cell much longer and can be fully processed in one pass through the catholyte chamber 158 from the BOP source tank to the BOP spent tank. It is then concentrated by a particle filter to collect alkali for use by the Fe anolyte. Using an average density for NiO(OH) CTP 200 of 4-gm/ml and molecular weight of 91.6934, then Ni is 64% of the NiO(OH) molecule. Assuming 50% particle concentration, there is 1.28 gm/ml or 2.18×10⁻² mole/ml of Ni in the catholyte suspension. That is 2.104 coulombs/ml of charge transfer capacity which, at 300 amps using the example above, discharges at 0.1426 ml/sec of NiO(OH). If the catholyte chamber 158 is also 0.15 cm wide with 100 cm² current collector area (15 ml volume), then the residence time for complete catholyte consumption is 105 seconds. There is no need to recirculate catholyte suspension through the BOP in the manner of the Fe anolyte. At recharge, the anolyte it is simply pumped through the cell in the opposite direction from that of discharge, whereby water is restored to the catholyte. Except for metal hydride (MH) anolyte suspensions, where total system water volume does not change, discharge (oxidation of the metals) reduces total system water volume and recharge restores it.

In the flow battery 102, the catholyte water volume is being maintained by cross-filter flow from the anolyte plus catholyte inflow to the cell from a source tank in the BOP; but, the catholyte becomes more alkali as the battery discharges. Therefore, it is advisable to start discharge with the catholyte at an almost neutral electrolyte (e.g., pH=8), which will increase in alkalinity as discharge proceeds.

The chemically discharged Ni(OH)₂ particle 222 is now bigger, less dense and lighter than before the collision of the NiO(OH) CTP 200 with the current collector 208 at position 200e. Because of these changes and its loss of momentum, the Ni(OH)₂ particle 222 now is drawn back into the TVF 202A along path 204b to position 202f, where it remains trapped within the TVF 202 as the larger, less-dense and discharged Ni(OH)₂ particle 222.

As the excess solvated K⁺ ions 218 in the catholyte are consumed to liberate H⁺ ions, more excess solvated K⁺ ions 218 are replenished by more K⁺ ions 218 moving from the anolyte to the catholyte. The solvated K⁺ cation 218 at position 218a is accelerated by the high-velocity peripheral TVF 206B to position 218b, then to position 218c, then to position 218d and finally to position 218e in the direction shown by arrows 224. At position 214e, the K⁺ ions 218 reaches the NiO(OH) CTP 200 to support the reaction described above.

The spinning filter 230, which is equivalent to the spinning filter 140 of FIG. 1, generates the TVF 202A,B that is bounded by CCF 206A,B as the filter 230 spins around the cell's centerline C/L as shown by arrows 232. The method of replenishment will be highlighted in conjunction with a description of the anolyte reactions.

If the electrical load 210 does not demand current, then the NiO(OH) CTP 200 does not undergo a metamorphosis to become Ni(OH)₂; however, the loss of momentum causes the CTP 200 to return to the TVF 202, still as NiO(OH) CTP 200. The NiO(OH) CTP 200 will continue to circulate in the TVF 202 and to contact the current collector 208; but, it will not undergo the transformation into the Ni(OH)₂ particle 222 until the electrical load 210 demands current.

In a conventional cell, there is no method for separating the reacted Ni(OH)₂ particles from the unreacted NiO(OH). Thus, the reacted Ni(OH)₂ can remain at or near the current collector or electrode and cause an increase the cell's internal resistance. TVF flow cells and batteries of this invention are different because they can exploit differences in the sizes, masses and densities of the two different materials so that mainly unreacted NiO(OH) CTP 200 can contact the current collector 208 and reacted Ni(OH)₂ particles 222 can remain trapped with the TVF 202A. The discharged Ni(OH)₂ particle 222 will later be drawn into the BOP. Meanwhile, the TVF cells 100 and batteries 102 can maintain their output powers so long as the supplies of charged catholyte and anolyte CTP 200 are not exhausted.

Returning to the description of the CCF 206A,B, the CCF 206A,B are parts of the same CCF that are distinguished here solely for the purpose of aiding in an understanding of this description. As noted above, the CCF 206A,B are generated because of the rotation of the filter 220. The principal difference between the CCF 206A and the CCF 206B is their shear rates.

Because the CCF 206A is adjacent the surface of the stationary current collector 208, its velocity at the surface approaches zero and remains low at the interface with the TVF 202B. Thus, the charged NiO(OH) CTP 200 can readily penetrate the CCF 206A and collide with the current collector 208.

By contrast, the CCF 206B is adjacent the surface of the spinning filter 230 and consequently the CCF 206B shear rate is high throughout its interface with the TVF 202B. Thus, the charged NiO(OH) CTP 200 cannot readily penetrate the CCF 206B and collide with or penetrate the spinning filter 230 even though it can penetrate the CCF 206A and collide with the current collector 208.

The ability of the CCF 206B adjacent the spinning filter 230 to keep particles, such as the NiO(OH) CTP 200 and the Ni(OH)₂ particle, from approaching the spinning filter 230 may be unique and is an important attribute of TVF cells, such as the flow cells 104A,B. Static filters and membranes in conventional electrochemical cells containing particles will become obstructed or clogged in the presence of solid particles. Much like a filter in a coffee-maker, static filters in conventional cells either limit the current densities of prior art cells or they need to back-flushed or replaced. Static filters affect performance and their service or replacement adds to cost. The spinning filter 230 does not clog, does not normally require service or replacement and does not lower cell current density.

If the electrical circuit 210 demands current, then the anodic half-cell reaction in Eq. (2) proceeds when electrons (e⁻) 220 freed during the anodic half-cell reaction of Eq. (2) transfer their charges to current collector 240 (giving it negative polarity as shown by an adjacent ‘−’ sign) and then to the electrical circuit 210. This collision and charge transfer simultaneously starts the cathodic reaction.

Iron (Fe) CTP 242 at position 242a within TVF 244A and accelerated through positions 242b, 242c, and 242d along path 246a until they penetrate CCF 248A and collide with the current collector 240 at position 242e. When the collision occurs, the CTP 242 provides a solvated Fe⁺³ ion (not shown) that is oxidized to a Fe⁺² ion 248 and the electron 220, which transfers its charge to the current collector 240.

After the collision, the Fe⁺² ion 250 then binds with a solvated OH⁻ ion 252 to form a Fe(OH)₂ particle 254 that is larger and less dense than the Fe CTP 242 so that it is drawn toward the center of the TVF 244A. The solvated excess K⁺ ion 256 is released that is now free to circulate in TVF 244B in the direction shown by arrows 258.

When the excess K⁺ ion 256 reaches a position adjacent the spinning filter 230, the solvated K⁺ ion 256 is drawn through the filter 230 by a convection gradient generated by the BOP, which keeps the anolyte pressure higher that the catholyte pressure—as shown by convection gradient arrows 260. Once in the catholyte at position 218a, the excess K⁺ ion 256 is swept by the TVF 202B to the surface of the current collector 208 where the excess K⁺ ion 256 promotes the reduction of the NiO(OH) CTP 200, as described above.

The convection gradient accelerating the excess K⁺ ions 256 and the TVF 202B do not exist in prior art cells. In prior art cells, the K⁺ ions in the anolyte slowly flow within the electrolyte in response to diffusion and concentration (but not convection) gradients toward the catholyte where they are opposed by the flow of OH⁻ ions moving in the opposite direction. When the two solvated ions meet, KOH dipoles are formed. As a result, very few K⁺ ions are available to replace H⁺ ions in water in order to provide H⁺ ions needed for the reduction of NiO(OH). Thus, the reduction of NiO(OH) in prior art cells is a rate determining step (RDS) that limits cell power to a very low level.

The reduction of NiO(OH) also is a RDS in TVF cells 100; however, the convection gradient and TVF 202B deliver many excess K⁺ ions 256 to the location 200e of NiO(OH) CTP 200 at the current collector 208. This permits the RDS in TVF cells 100 to reach a very high level of chemical activity.

There also is an energy determining step (EDS) that can limit the energy provided by the cell. In conventional cells needed to provide high current densities, the rate of providing OH⁻ ions to the anolyte is very low and this causes a deficiency of OH⁻ ions that are needed to oxidize all of the iron available for the anolyte reaction. TVF cells do not suffer that limitation.

The reason that prior art cells have a deficiency of OH⁻ ions that are needed to oxidize all of the iron available for the anolyte reaction is shown in the following calculations. To start, KOH has a molecular weight of 56.1 grams/mole. A 5-molar (0.005 moles/ml) concentration of KOH is about as concentrated as is practical in a 23% KOH solution of Fe—KOH suspension. The KOH in such a Fe—KOH suspension weighs 280.5 grams/liter. Fe has atomic weight of 55.845 grams/mole and density of 7.874 grams/ml or 0.141 moles/ml. In a 50% Fe/50% liquid by-volume anolyte suspension, there are 0.0025-moles of KOH to oxidize 0.0705-moles of Fe. However, 2-moles of OH⁻ ions are required to oxidize 1-mole of Fe. That means, if all the OH⁻ ions originally supplied in the electrolyte are reacted, then only (½)(0.0025)/0.0705=0.01773 moles of Fe, or a little better than 1.5% of the Fe, can be oxidized. If a 60% Fe/40% liquid by-volume anolyte suspension is used, then an even smaller percentage of Fe can be oxidized. Thus, the total energy available from the original OH⁻ ions in a prior art cell is very limited and constitutes an EDS.

Electrolyte convection gradient flows are an important characteristic of electrochemical cells 100 of this invention. The TVF flow battery 102 that is conceptually diagrammed in FIG. 2A contains means (including input duct 262 connecting the first or catholyte chamber 158 to the BOP, the BOP and output duct 264 connecting the BOP to the second or anolyte chamber 156) for creating convection gradients that flow the electrolyte from the first of the chambers (156, 158) to the second of the chambers (158, 156) in a first direction (as shown by the convection gradient arrows 260) through the spinning filter 140. These means also contain means for flowing the electrolyte in a second direction (as shown by convection gradient arrows 266) opposite the first direction and around the spinning filter 140. Thus, the K⁺ cations 256 can flow under convection gradients through the spinning filter 230 while the OH⁻ anions 216 flow under convection gradients around the spinning filter 230 so that the two ions do not form KOH dipoles near the spinning filter 140. Instead, the OH⁻ anions 216 are recycled from the catholyte to the anolyte for oxidation of the Fe CTP 242 to cations (e.g., Fe⁺²) 250 after filtration to remove Ni(OH)² particles 222 or other undesirable reaction products.

The catholyte contains the K⁺ ions 218 paired with the OH⁻ ions 216 in dipoles. Ni(OH)₂ particles 222 and water are also present. The catholyte containing all of these components is pumped through the BOP input duct 262 to the BOP where it is filtered so that the K⁺ ions 218 paired in dipoles with the OH⁻ ions 216 can be pumped from the BOP through the BOP output duct 264 into the anolyte. Once in the anolyte, the recirculated OH⁻ ions 216, 252 can continue to oxidize the Fe CTP 242 until all of the Fe has been reacted. This dramatically increases energy density of electrochemical cells 100.

One advantage of incorporating means for (re)cycling anions from the catholyte to the anolyte is that by separating paths for the anions from paths of cations in the anolyte that are moving toward the catholyte is that those ions do not meet and form dipoles. Instead, they remain available to participate in redox reactions.

Separation of ion paths is not practical in prior art batteries that do not incorporate means for generating TVF 202A,B to maintain separation of catholyte and anolyte solutions containing particles. One reason is that separation of solutions with an ion-transfer membrane (e.g., NAFION and lithium-ion membranes) currently are only available for transferring H⁺ and Li⁺ ions cations and not for any anions. Another reason is that separation with filters is not practical because the filters will clog with particles and precipitates in electrolytes. The TVF flow battery 102 can also work with LiOH electrolytes where Li⁺ cations are pumped through the spinning filter 140, 230.

The flow of excess solvated K⁺ ions 218, 256 through the spinning filter 230 provides lower cell internal impedance than can be obtained in prior art static cells. Those excess K⁺ ions 256 were created in the anolyte where the Fe CTP 242 are oxidized to become Fe⁺ ions 250, which absorb 2OH⁻ at the current collector 240 surface. The K⁺ ions 256 are then released to TVF 244B, which carries them to the spinning filter 230 in about 0.5 to 1.0 millisecond. Those K⁺ ions 256 arrive at the current collector 208 surface via TVF as rapidly as they leave the current collector 240 surface where they participate in NiO(OH) CTP 200 reduction as described above. The process creates additional, increasing alkali concentration in the catholyte.

Prior art cells having no ion-selective barrier (i.e., common electrolyte between static porous electrodes) will have diffusion and concentration gradient flows in the wrong direction for OH⁻ ion mass transport to the anolyte due to a decrease of H₂O in the catholyte. That problem does not arise in the TVF flow cell battery 102 because it contains means for separating cation flows from anion flows, which have been described.

During discharge, the catholyte accumulates KOH alkali and decreases water in the suspension simultaneously; so that the catholyte pH is rising as it becomes more alkali. For that reason, the catholyte can start the discharge process at a pH that is near neutral (e.g., pH=8) and continue to absorb OH⁻ anions to about a 5-molar alkali concentration, which will not accurately register on a pH meter. K⁺ cations are being pumped across the rotating filter at about a 5-molar concentration. Processed catholyte effluent particle suspension is pumped into the BOP and (after filtering and decanting the concentrated alkali) is either recirculated to a source tank or enters a processed material tank (neither shown). The catholyte at a higher alkali concentration is passed in the BOP through a particle filter (e.g., U.S. Pat. No. 5,034,135 of 1987 to H. Fischel) to concentrate the particle suspension and cycle highly-concentrated KOH liquid to the anolyte source tank (not shown). Thus, the anolyte is continuously supplied through the BOP output duct 264 with KOH made in the catholyte. This method will provide anolyte with sufficient alkali to process stoichiometrically all of the metal cations (e.g., Fe⁺²).

The pressure differential between the catholyte and the anolyte does not harm cell performance because the TVF 152, 154, 202, 232 will not allow the particles 200, 216, 230, 248 to cross, foul or plug the spinning filter 140, 230. During the charge cycle, overpressure is reversed so that the catholyte pressure is slightly greater than the anolyte pressure. Water is created in the catholyte to restore it to low pH while alkali produced in the anolyte by release of OH⁻ restores its higher pH electrolyte. Because of this unique dynamic, the K⁺ ions 218, 256 mainly cross the spinning filter 140, 230 in either direction; thus, preserving the preferred low-alkali concentration in the catholyte and a high-alkali concentration for anolyte over many charge/recharge cycles.

The CTP 200 in this embodiment is a nickel compound chosen for both its cathodic electronegativity with respect to the anodic electronegativity of the iron CTP 242, its chemical compatibility with its electrolyte and its density. One set of suggested metals candidates for constructing the CTP 200 and 242 are metals from Period 4 of The Period Table of the Elements that have atomic weights greater than calcium. These metals are referred to here as the heavy metals. CTP 200 and 242 may be round, regular polyhedrons, irregular polyhedrons (e.g., flakes) a combination of some or all of them having sufficient size and density so that they are accelerated and ejected from a TVF and collide with sufficient momenta against a current collector to cause charge transfer and a redox reaction that transform the CTP into a less dense particle that will re-enter the TVF and remain there during cell discharge.

Elements such as the alkaline metal and the alkaline earth metals (Groups 1 and 2) of The Period Table of the Elements) have very desirable electronegative properties (higher voltages) and are referred to here as the light metals. The light metals may require non-aqueous electrolytes and those less dense than calcium cannot acquire sufficient momenta to penetrate the peripheral TVF 202B. In order to use the light metals, a catholyte CTP 270 can be constructed as shown in FIG. 2B to comprise aggregate sintered catholyte particles. The light metal catholyte CTP 270 may comprise a dense inactive metal core 272 (e.g., SS) encapsulated by a Group 1 or Group 2 metal cover 274 that may include metal flakes 276 of other Group 1 or Group 2 metal flakes. By using the metal core 272, the CTP 270 will have both sufficient size and density to penetrate the peripheral TVF 202B.

CTP need not be restricted to the configuration of FIG. 2B. FIG. 2C illustrates a CTP core 280 composed of sub-micron particles 282 of heavy metals, such as Fe and Zn, as well as SS, that can be sintered together in order to increase net mass. Sintering of the metal particles 282 should be controlled so that the CTP core 280 has internal pores 284 that can be wetted by electrolyte. Light metals can be plated onto the pores 282 of the CTP core 280 in order to acquire necessary mass, density and size. Graphite particles 286 (e.g., graphene, carbon nanotubes) can be placed in the internal pores 284.

Fine (sub-micron) powders of heavier metals, such as Fe, metal hydrides (MH) and Zn can be sintered into the larger aggregate particles of greater net mass, conceptually illustrated in FIG. 2C. Sintering of these particles should be controlled so that the aggregate particles have internal porous structures that can be wetted by electrolyte.

The flow battery 102 can be considered as a secondary battery. Rechargeable metals are mainly Fe, metal hydrides (MH) and Cd. Zn(OH)₂ tends to form ZnO in water, which is more difficult to recharge.

The flow battery 102 does not have to contain means for recharging the electrolytes. Means for recharging the electrolytes can be contained within the BOP where spent catholyte Ni(OH)₂ particles 222 can be converted back to NiO(OH) CTP 200 and depleted anolyte, e.g., Fe(OH)₂ particles 254 can be changed back to Fe CTP 242 by either chemical or electrochemical processes. If recharging electricity is supplied by solar, wind, nuclear or waterpower sources, then the flow battery 102 can be considered a ‘green energy’ source because it does not emit any pollutant.

In the embodiment just described, the principal metals are nickel and iron—both of which are plentiful, inexpensive and environmentally friendly. These are the same materials used by Thomas A. Edison to build his long-lasting and reliable batteries that are described in his U.S. Pat. No. 678,722 of 1901 and U.S. Pat. No. 692,507 of 1902.

Unlike the Edison or standard batteries where energy is limited to the size and weight of electrodes, the flow battery 102 can continue to deliver electrical energy so long as it is supplied with charged anolyte and catholyte CTP. Also unlike the Edison batteries where power is limited because charge transfer depends on ion movements restricted to low diffusion, concentration and migration gradients, the flow battery 102 can deliver higher power because 1) charge transfers occur when CTP are propelled toward collisions with current collectors, 2) ions needed for chemical reactions at the current collectors flow as filtered electrolyte directly to those surfaces by rapid TVF forced convection and 3) electrode surfaces are depolarized because redox reaction products are swept away by energetic TVF shear forces.

While the Edison battery has earned its well-deserved reputation for long, reliable service, the same cannot be said for most other cell electrochemistries where electrode failure is common due to fouling, internal component expansion, depletion or corrosion. The flow battery 102 greatly reduces or eliminates a need for electrode or cell replacement because redox reactions occur at CTP that are readily replenished by the BOP and the current collectors are made from chemically-inactive or passivized metals.

Conventional batteries and flow cells depend on both redox reactions and charge transfers taking place at or in electrodes where energy densities, power densities or both are limited by electrode size or ion transport gradients. Electrode design therefore requires tradeoffs of electrode properties to achieve an acceptable balance of performance characteristics. This is not necessary because all of the features and advantages of the flow battery 102 over prior art cells are the result of the novel separation of redox reactions from current collection through the use of CTP that can be tailored for optimum performance.

### The Metal-Air Flow Battery

The economics of the flow battery of FIG. 1 can be improved by reconfiguring electrochemical cell 300 to become a metal-air flow battery 302 of FIG. 3A, where catholyte now depends on O₂ from air to provide solvated (OH)⁻ anions. This is important because 1) conventional batteries can require six-times as much catholyte as anolyte by volume, 2) catholyte-related discharge chemistry can be very much slower than the anode metal discharge rate and 3) catholyte CTP are much more costly to provide and to use than air.

The metal-air flow battery 302 is similar in construction to the flow battery 102 of FIG. 1. Identical reference numerals from FIG. 1 are used in FIG. 3A where the components are equivalent. The major differences are in the structure of the porous positive outer cylindrical current collectors 308A,B, addition of oxygen manifold 370 having a porous wall 372A,B, an oxygen (O₂) port 374 and composition of the catholyte. LiOH aqueous electrolyte for catholyte and anolyte replaces KOH used in the flow cell 102.

The solid positive outer cylindrical current collectors 108A,B of FIG. 1 have been replaced by porous positive outer cylindrical current collectors 308A,B. The inner radial surfaces of the current collectors 308A,B define the outer surface of the outer electrolyte chamber 156 containing catholyte.

The outer radial surfaces of the current collectors 308A,B are attached to porous wall 372A,B of the oxygen manifold 370 The manifold is connected to the oxygen port 374 so that oxygen from an external source (not shown) in the BOP (not shown in FIG. 3A) can be pumped through the oxygen port 374, the manifold 370 and its porous wall 372A,B into the outer electrolyte chamber 158.

The BOP contains a vacuum swing adsorption oxygen generator (not shown) that supplies 90-to-95% pure molecular oxygen (O₂) from air. The molecular oxygen (O₂) is water-saturated to help maintain hydroxide balance within the alkali cell. Most of the 5-to-10% of the remaining air constitutes nitrogen, which forms bubbles in the catholyte that are trapped within the TVF 152,154 and expelled in the BOP. Some of the remaining gas is CO₂ that enters the outer electrolyte chamber 158 and becomes trapped within the TVF and removed by the BOP.

Instead of the NiO(OH) faradaic particles used for the CTP 200 in the flow cell of FIG. 2A, widely dispersed, carbon supported, catalytic nanoparticles of doped Me-MnOₓ (Me=Ni, Mg) are used as cost effective typical catalyst for the ORR. Me-MnOₓ on glassy carbon (a highly porous graphene structure) has been shown to be as (or more in some cases) active as Pt/C (platinum on carbon) for the ORR and will be abbreviated to Mn/C hereinafter for convenience. The Mn/C particles act to catalyze adsorbed molecular O₂ and 2H₂O to atomic O⁻² that combines to make four freely-solvated (OH)⁻ anions needed to enrich the aqueous anolyte hydroxide electrolyte in accordance with the following process.

The half-cell catholyte reaction equations are:

(1/2)O₂+2Li⁺+2e⁻→Li₂O(initial) Eq. (3)

Li₂O+H₂O→2(Li⁺+OH⁻)(final) Eq. (4)

The electrolyte is preferably and exclusively LiOH because the Li⁺ cation can be rapidly catalyzed to react with dissolved oxygen to form Li₂O. Li₂O is soluble in water to at least 2-molar concentration at 0° C. to form the hydroxide. Thus, the Li⁺ ion is an effective cation substitute for the low concentration of H⁺ ions in alkali since the other Group I metals cannot be as easily catalyzed to reduce O₂.

The reaction is orders-of-magnitude faster than dissociation of water in alkali. In the same manner as the discharging TVF flow battery 100, water and the Li⁺ cation are supplied to the catholyte by cross-filter flow from the anolyte to support the oxygen-lithium reaction. As shown by Eq. (4), the alkali created by that reaction is filtered from recirculated catalyst and delivered to the anolyte through BOP for further oxidation of metal as previously described. The catholyte suspension contains only catalyst particles that are not chemically altered by the reaction. Therefore, they can be continuously recirculated through the cell and BOP where they are filtered, concentrated and separated from a significant portion of LiOH alkali to be used by anolyte.

Large source and spent tanks containing cathodic particles, as described for use with the TVF flow battery 102, are not needed for the metal-air flow battery 302. Controlled pressure gradients cause the solvated Li⁺ cation to flow from the inner electrolyte chamber 156 through the cylindrical spinning filter 140 to the outer electrolyte chamber 158.

If the metal-air flow battery 302 is to be used only for discharging the metal as fuel (to be recharged in BOP), then the inner chamber 156 and outer chamber 158 components and suspensions can be reversed as to polarity with flows being oriented radially inward rather than outward. It is preferable to have the direction of differential flows arranged so that liquid flows radially inward through the filter. Centrifugal forces assure that no particles can follow.

The Mn/C nanoparticles have the consistency of fine powders and lack both the density and size to act as CTP. Therefore, they must be incorporated in a larger and denser particle. FIG. 3B is a cross-section of a CTP 380 having a SS core 382 encased in a sheath of porous carbon 384 (e.g., graphene, graphite, nano-tubes, etc.) to which Mn/C particles 386 are firmly attached and supported. Mn/C catalyst particles (not shown) may also be deposited on the graphene-coated electrolyte-facing surface of current collector porous wall 372A,B.

As shown in FIG. 3B, the CTP 380 is entrained in catholyte 388 that contains an Inner Helmholtz Layer (IHL) and an Outer Helmholtz Layer (OHL). The IHL and the OHL form an electrical double layer (EDL) in the electrolyte that encapsulates the CTP 380. The EDL refers to two parallel layers of charge surrounding the CTP 380 that form a capacitive electrical energy store. The IHL is an electrical surface charge (either positive or negative) comprising ions adsorbed directly onto the CTP 380 due to chemical interactions. The OHL is composed of ions attracted to the surface charge because of the coulomb force electrically screening the IHL. The OHL is loosely associated with the CTP 380 because the OHL is made of free ions that move in the catholyte 388 under the influence of electric attraction and thermal motion rather than being firmly anchored. The EDLs are the sites of electrical charges that are subsequently transferred to the current collectors 308A, B.

Conventional galvanic cells comprising porous electrodes, such as taught by Bockris et al, Modern Electrochemistry 2B, 2^{nd} ed., ®1998, Klewer Academic/Plenum Publishers, New York, §13.5.1—‘Special Configurations of Electrodes in Electrochemical Energy Converters”, pp. 1811-14 as well as typical proton exchange membrane (PEM) membrane electrode assemblies (MEA) containing stationary or static catalyst structures, are fundamentally different structures from TVF galvanic cells incorporating catalyst structures taught here. In conventional fuel cells, charge transfer (current density) occurs within electrode pores and is primarily restricted to a narrow band of electrolyte within a meniscus where the meniscus is approximately 10-nanometers thick and in contact with catalyst on interior walls of the pores—as shown in Bockris et al FIGS. 13.12 & 13.13.

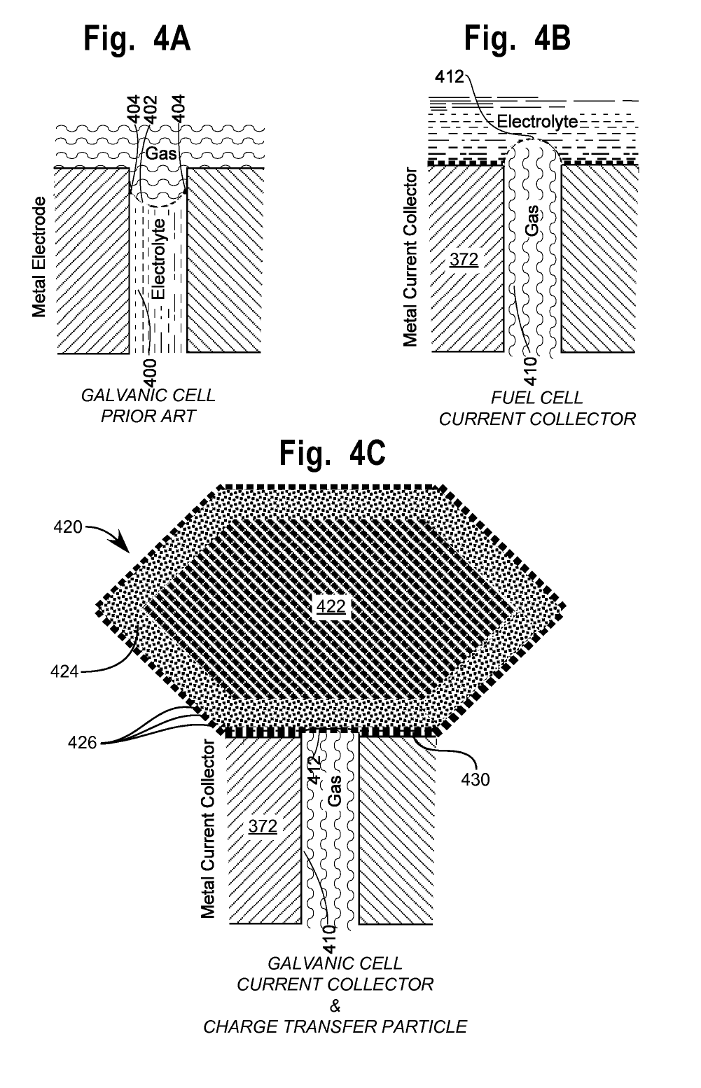

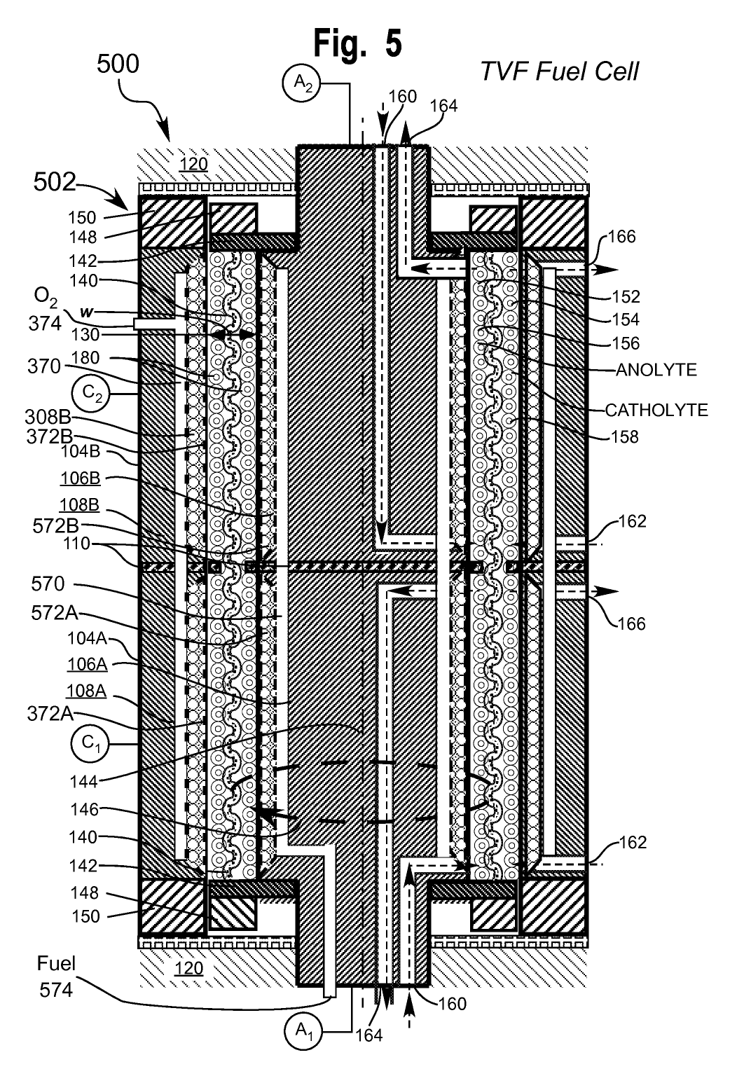

FIG. 4A, taken from Bockris et al at FIG. 13.12, is a schematic representation of a three-phase interface in a single pore when the meniscus contact angle is a few degrees. Pore 400 in a fuel cell Metal Electrode contains both electrolyte and a gas selected from a set consisting of fuel and oxidizer. A portion of the pore 400 wall is coated with or holds a catalyst.

A meniscus 402 separates the electrolyte from the fuel or oxidizer gas. The meniscus' surface tension regulates the amount of gas penetrating into the electrolyte. As the diameter of the pore decreases, the total catalyst surface area for a cell's electrode can increase; however, the surface tension of the meniscus also increases and less gas is able to penetrate the meniscus 402 and dissolve into the electrolyte. Therefore, a tradeoff between total catalyst surface area and the amount of gas penetration to the catalyst surface can exist.

The distance from the meniscus 402 to the wall of the pore 400 where the catalyst is located is critical to performance of the cell. Zone 404 illustrates where optimum results (e.g., highest current) can be obtained for a three-phase redox reaction of gas dissolved in electrolyte adjacent to catalyst. As explained in more detail in Bockris et al, if the distance is too high, then there is a large increase in limiting diffusion current. If the distance is too low, then there will be too much resistance to the flow of reaction products back to bulk electrolyte. Thus, electrolyte and gas pressures have to be stringently regulated to assure that optimum distances occur where the catalyst resides.

The volume of gas solvated in electrolyte of a conventional galvanic cell can be increased by raising gas pressure; however, raising the pressure will require more accurate regulation to prevent an escalation in both the amounts of wasted gas and mechanical stress on the cell's proton exchange membrane (PEM). The process of solvating gas in the electrolyte also can be accelerated by increasing temperature both to increase solubility and to lower meniscus surface tension; however, temperature is limited by a need to preserve structural integrity of the PEM. Alternatively, surface tension of the meniscus can be reduced by raising humidity of the gas (e.g., 80%); however, adding water will require more accurate control of gas pressure to prevent rupture of the meniscus. These limitations on pore size, gas pressure, temperature and humidity combine to set low limits (e.g., <1000 ma/cm²) on conventional galvanic cell current density.

Once there is a redox reaction, reaction products must diffuse through the electrolyte in order to accommodate fresh gas reaching the catalyst. The requirement is difficult to satisfy for conventional cells because two gradients operating in opposing directions must occupy the same space.

As can be seen from FIG. 4A, only a small fraction of static catalyst surface of the electrode in conventional cells participates in a redox reaction; namely, the zone 404 where the catalyst, the electrolyte and the gas are all simultaneously present. The reaction is also restricted by mass transport rates. These two effects have not been separated in most experiments characterizing SA of various catalysts.

A theoretical calculation of the oxygen reduction reaction (ORR) on platinum (Pt) was made in Koper, Ed., Fuel Cell Catalysis—A Surface Science Approach, ®2009, John Wiley, NJ, §3—‘Electrocatalysis and Catalyst Screening from Density Functional Theory Calculations’ pp. 70. No mass transport limitations were taken into account because a vanishingly thin layer of electrolyte covering the entire catalyst area was assumed. A pH=0 was also assumed. Under such idealized conditions, sites are able to cycle the reaction at 200 times per second and produce a current density of 96 mA/cm² of catalyst surface when measured experimentally using a rotating disc electrode (RDE). Koper, §15—‘Size Effects in Electrocatalysis of Fuel Cell Reactions on Supported Metal Nanoparticles’ pp. 533-536, reported the current density is 0.2 to 0.3 mA/cm² (FIG. 15.7 at p. 536). These are 0.2 to 0.3% of the theoretical value. Even highly active hydrogen produced, at most, 27 mA/cm² (page 532) and it was reported that the RDE would have to spin at 4.6×10⁸-RPM to eliminate the mass transport diffusion decrement through electrolyte; obviously not feasible.

While it is not possible to separate mass transport effects from 3-phase pore morphology effects vis-à-vis catalyst SA, a useful estimate of static catalyst effectiveness can be estimated. The surface area of highly-dispersed 3-nm platinum particles is 100 m²/gm. Typical hydrogen fuel cells incorporate about 0.2 mgm of platinum catalyst per cm² of projected electrode area, which yields about 200 cm² of platinum catalyst surface area per cm² of projected electrode area. For a hydrogen oxidation reaction (HOR), this amount of platinum catalyst produces a current density of about 0.5 A/cm² of projected electrode area. That estimate of current density is equivalent to 2.5 mA/cm² of platinum catalyst surface area or about 10% of the best experimental result for platinum catalyst using a RDE test to characterize platinum. The complementary ORR catalyst density is usually higher, at 0.5 mgm of platinum catalyst per cm² of projected electrode area or 500 cm² of platinum catalyst surface area per cm² of projected electrode area. At 1 mA/cm² of platinum catalyst surface area, the oxygen cathode operates at about 1% of theoretical catalyst efficiency.

The total volume of platinum catalyst particles in the static catalyst structure examples is only 0.3% of the volume of a typically 30 μm thick active porous electrode layer adjacent the electrolyte or PEM. This means that the Pt particles only sparsely cover the electrode and the distance between particles is greater than the diameter of a virtual sphere enclosing a particle. Gas molecules diffusing through such a sparsely-seeded structure must waste a substantial portion of residence time while migrating to and react with catalyst particles.

The porous electrodes of the conventional fuel cells contribute to the internal impedance of the cells and limit electric current density for the following reasons:
Static catalyst structures are inherently limited to low current densities (e.g., decreasing pore sizes increases electrolyte meniscus surface tension—thereby decreasing gas solubility).
Narrow diameters of the pores impede the purging of reaction products moving outward from the pores and retard movement of electrolyte with dissolved gas inward to redox sites.
Ions (e.g., protons, hydroxides) are only propelled by diffusion, concentration and migration gradient forces that only cause relatively slow velocities as the ions cross the cell's internal chemical circuit.
If CO or other harmful reaction products are produced, then an inability to promptly remove them may cause poisoning of the catalysts.
Electrolyte pressures and levels must be precisely monitored to prevent flooding of electrode pores, which would block gas access to the catalyst.
Where the electrode comprises catalyst supported on porous carbon and the porous carbon serves both as a diffuser of gas reaching the catalyst and an electrical double layer (EDL), then electrolyte necessary for charging the EDL restricts the flow of gas necessary for the redox reaction at the catalyst.
   None of these limitations exist in TVF galvanic cells.

FIG. 4B is cross-sectional view of a fuel cell pore 410 in a metal current collector (e.g., 106, 108, 308) of this invention. In contrast to the pore 400 of FIG. 4A the pore 410 of FIG. 4B contains only gas. While electrolyte may be hydrophilic with respect to the pore 410 walls, it does not form an internal meniscus similar to the meniscus 402 of FIG. 4A because gas pressure creates an external electrolyte meniscus dome 412 outside of the pore. Since the pore 410 walls do not contain catalyst, the gas and electrolyte pressures need only be regulated to assure that electrolyte does not flood the pores and that the meniscus dome 412 does not become an ejected bubble that allows gas to escape into the electrolyte.

The gases penetrating the current collector pores reach current collector porous wall 372A,B surfaces that are covered by electrolyte. The gases are restrained by electrolyte surface tension and form nano-size to micron-size convex domes 412 that protrude from the current collector 106, 108 surface pores. As will be described, these domes 412 are broken by particles in the electrolyte that collide with the current collector porous wall 372A,B surfaces. Liberated gas, momentarily trapped and compressed between the current collector porous wall 372A,B surfaces and the CTP 380 surfaces, is then forced into solution with the electrolyte attached to the carbon-supported catalyst on the CTP surfaces. In contrast to conventional fuel cells where the gases and electrolyte must penetrate the electrode pores, no electrolyte enters the TVF current collector pores.

The pores 410 occupy only 15-25% of the current collector porous wall 372A,B area, which can be very strong mechanical structures. The exuding gas meniscus domes 412 cover much of the current collector porous wall 372A,B surfaces. Because the CCF 246A boundary layers cover static current collector surfaces, the gas does not leave the current collector porous wall 372A,B surfaces unless forced by excessive gas pressure.

In this embodiment, the Mn/C particles as carbon-supported ORR catalyst necessary to promote the three-phase reactions do not reside in the pore walls 372A,B; but, on CTPs 420 as shown in FIG. 4C. As an option, they may also coat the current collector porous wall 372A,B electrolyte facing surface. A typical CTP 420 comprises a metal core 422 surrounded by a rough-surfaced skin 424 of electrically-conducting material, such as carbon (e.g., graphene, graphite, nano-tubes, etc.), on which Mn/C catalyst particles 426 are supported.

The CTP 420 has a mass of at least 10⁻⁶-grams. When it collides with the current collector porous wall 372A,B surface, it ruptures the meniscus dome 412. The O₂ gas from the pore 410 immediately dissolves into the local electrolyte between catalyst particles 426 and the current collector porous wall 372A,B surface before reacting with the electrolyte to create OH⁻ anions that rapidly disperse in the catholyte. This is a very active reaction that produces many more OH⁻ anions than the conventional electrode because the surface of the current collector porous wall 372A,B is many times greater that the active surface of the interior of the pore zone 404.

An alternate construction comprises covering the surface of the current collector porous wall 372A,B with Mn/C particles (not shown). This option can be used with CTP 420 that have MnO₂ catalyst in their covers. In that case O₂ gas is trapped and compressed between catalytic surfaces separated only by Helmholtz electrolyte layers. Under such conditions the O₂ gas is quickly solvated and reacted.

The anolyte in the metal-air flow battery 302 comprises Fe particles suspended in LiOH; however, other formulations are practical. For example, other low-cost, heavy metals such as Mn, Co, Ni, Cu, Zn or metal hydrides denoted as MH can be used with or in place of Fe.

Heavy metal suspensions enter at anolyte entry ports 160. The metal particles exit at anolyte exit ports 164 as oxidized metal in the form of hydroxides or oxides. The volume of ORR catalyst e.g., MnO₂ CTP 380 in catholyte suspension remains constant and is recirculated through the outer electrolyte chambers 158 after parasitic nitrogen is released in the BOP facility.

The embodiments taught with FIGS. 1 and 2A describe terminals Ti_{1,2} as having negative polarity and terminals To_{1,2} as having positive polarity. The same is true for the embodiment taught with FIG. 3A and incorporating heavy metal CTP. However, the embodiment taught with FIG. 3A can be reversed, which causes the terminal Ti_{1,2} and To_{1,2} polarities to change so that the terminals Ti_{1,2} have positive polarity and the terminals To_{1,2} have negative polarity because the positions of the catholyte and anolyte are exchanged.

Mn/C catalyst particles 380 have been described as having metal cores 382 to raise their net individual particle masses up to 10⁻⁶ to 10⁻⁵ gram. The metal cores 382 are coated with graphene or one or more activated forms of carbon. Carbon serves as a substrate for the nano-scale dispersed Mn/C ORR catalyst particles. Other catalyst particle types may be used in place of Mn/C.

FIG. 4C illustrates what happens when the CTP 420 strikes the current collector porous wall 372A,B with sufficient force and pressure which, according to examples presented by Ma et al must be several hundred psi. Calculations shown above described that this is possible with TVF and appropriate CTP specifications. O₂ gas previously contained in the porous walls 410 by the electrolyte meniscus dome 412 is forced sideways and into solution in fluid layers 430.

Given the pressure of the CTP 420 striking the current collector porous wall 372A,B and dissolved O₂ gas concentration in the catholyte, two O²⁻ ions are formed first by rapidly combining with four Li⁺ ions to form two Li₂O molecules. Each of the Li₂O molecules then combines with two H₂O molecules to form four LiOH molecules in the catholyte. The chemical reaction is accelerated by forced convective flow of Li⁺ ion-rich electrolyte from the anolyte where it is released to the catholyte across the spinning filter 140. This ORR reaction would be much slower in ordinary (non-lithium) alkali because H⁺ cation concentration is lower and other Group I and II cations cannot be readily catalyzed to reduce oxygen.

The OH⁻ anions are sequestered as solvated LiOH alkali within the TVF 154 and travel with effluent catholyte to the BOP. There the catalyst particles are filtered from a substantial portion of the electrolyte and recycled to repeat the process in the catholyte. The supernatant electrolyte contains concentrated LiOH alkali which is returned to the anolyte from the BOP.

Upon oxidation of any metal CTP, the OH⁻ ions form metal hydroxides as end-points in the anolyte. That reaction forms Li⁺ ions that are immediately transported through the spinning filter 140. These solvated ions, having crossed the spinning filter 140, enter the Helmholtz layers IHL, OHL of FIG. 3B, which cover the catalyst particles 386 on the catholyte CTP 380 of FIG. 3B. The Li⁺ ions immediately combine with catalyzed O⁻² ions to form a soluble lithium oxide in aqueous alkali upon contact with current collector surface 372 of FIG. 4C. The unidirectional reaction is very much faster than the ORR in alkali not containing Li+ cations in the electrolyte.

A 90% O₂ feed to the porous cathode is recommended. The O₂ feed can be obtained from a vacuum-pressure swing adsorption (VPSA) oxygen generator comprising molecular sieves. O₂ delivered by VPSA generators is nearly dry. For alkali electrolyte, the O₂ should be wetted or saturated with water before entering the catholyte chamber 158 through the oxygen port 374. That can be done in BOP by bubbling the O₂ through the catholyte suspension. The TVF metal-air flow battery 302 works at ambient temperature; but, it will work better at a warmer temperature. The battery 302 can start cold and should be allowed to use its own thermal losses to heat to a temperature higher than 100° C. for better ORR catalyst performance.

The amount of oxygen required by the system configured in a typical embodiment used as an example above has been calculated as follows. A typical cell having 100 cm² of current collector surface and producing 300 amps of electrical current requires 300/zF moles/sec, where z=4 for the oxygen molecule. The molar oxygen flow rate is 7.77×10⁻⁴ moles/sec. At 24.2 L/mole for room temperature and std.-atm, the oxygen gas flow rate is about 67.7 liters/hr or 1.13 L/min. Thus, a small (15 to 30 lb.) VPSA oxygen generator can produce that much 95% pure O₂ on a continuous basis. If the system is used as a backup to an air breathing fuel cell, then O₂ can be obtained from a system oxygen reservoir tank, which will assure a quick startup for components requiring oxygen.

### The Fuel Cell

FIG. 5 is a cross-sectional view of electrochemical cell 500 showing essential features of a preferred embodiment of a fuel cell 502 that shares many of the structural features of the metal-air flow cell 302 of FIG. 3. The fuel cell 502 additionally contains a fuel manifold 570 that has a porous metal wall 572A,B attached to the current collector 106B and that has pores opening into the inner electrolyte chamber 156. Fuel enters through a fuel port 574 and flows into the fuel manifold 570 before passing through the porous metal wall 572A,B to form menisci with the anolyte in the inner electrolyte chamber 156. These additional components are associated with the negative inner current collector 106A,B in the same manner as the oxygen manifold 370, the porous wall 372A,B and the oxygen port 370 are associated with the positive outer current collectors 108A,B.

Fuel oxidation catalysis at the elevated temperatures of the TVF fuel cell can effectively employ inexpensive non-noble metal nanoparticles such as lithiated LiNiOₓ or LiMnOₓ oxides. Just as metal oxidation is faster in alkali electrolyte, the same holds for fuel oxidation catalysis. The opposite holds for the aqueous ORR, which is faster in acid (pH≦7), except for the Li⁺ cation process outlined above and more fully explained below. It is a distinct advantage of the TVF (rotating filter) fuel cell that either mode can be used and at substantially higher temperature greater than 250° C. EMD Millipore (OMNIPORE™ PTFE) filter media is one example of filter media that can be used with acid or alkali at an elevated temperature. It is a further advantage that liquid media (solutions) can cross the filter in a preferred direction without conveying any gasses or particles through the filter. These advantageous features are now demonstrated in an acid-electrolyte direct methanol (CH₃OH) fuel cell (DMFC).

The DMFC reactions in typical acid electrolyte are summarized as follows:

2CH₃OH+2H₂O+→2CO₂+12H⁺+12e₋(anode) Eq. (5)

3O₂+12(H⁺+A⁻)+12e⁻→6H₂O+12A⁻(cathode) Eq. (6)

2CH₃OH+3O₂→2CO₂+4H₂O(overall) Eq. (7)

The A⁻ anion represents any suitable strong acid. Clearly, the cathode reaction benefits from a substantial H⁺ cation concentration available to the ORR in Eq. (6) because of strong acid dissociation. However, anode chemistry kinetics operates at a disadvantage of having to both separate H⁺ (H₃O⁺) from water in the presence of a high concentration (acid) of that ion as well as split (dehydrogenate) the OH⁻ anion. Consequently, anodic oxidation of methanol is typically slower in acid than alkali.

Unique to the TFV flow batteries 102, 302 and the fuel cell 502 is the ability to reversibly exchange solutions between anolyte and catholyte compartments without mixing particles or gases as well as circulate the filtered, concentrated and separated liquid component between these compartments. This greatly simplifies volume, concentration and water management, which remains a serious ongoing problem for PEM fuel cells.

As shown in Eq. (5), the anolyte needs water produced by the catholyte (Eq. 6) as well as the anion, A⁻ to depolarize its current collector 106A,B where 12 H⁺ ions could otherwise accumulate and stop the reaction. In order to promote the most favorable chemical kinetics, the added water volume bearing anion, A⁻, (Eq. 6) flows through the spinning filter 140 to the anolyte to supply both the water and the anion.

Acid concentration increases in the anolyte which flows into the BOP, where particles are removed by filtration, and then returned to the catholyte. This ionic circulation loop is only possible because TVF 152, 154 in both suspensions keeps the catholyte and the anolyte catalyst particles from passing through the spinning filter 140.

The choice of ion circulation direction is not arbitrary. The anion, A⁻, is deliberately chosen to pass through the spinning filter 140 within the cell because 1) the ORR operates rapidly in its ambient acid environment and 2) is depolarized by excess water flow out of the catholyte chamber 158. The catholyte flows in the opposite direction through the BOP and around the spinning filter 140. Furthermore, the anion is needed to depolarize the current collector 108A,B which accelerates the reaction well beyond that achieved in PEM fuel cells. The anion also forms more acid that can be returned to the catholyte through BOP (not shown in FIG. 5), which controls catholyte pressure and its metered flow.

Some of the concentrated acid accumulated on the anolyte chamber 156 (Eq. 5) is first separated from the CTP 420 suspension by a rotating membrane filter (e.g., U.S. Pat. No. 5,034,135 of 1987 to H. Fischel). The particle-free acid is returned to a BOP catholyte storage tank (not shown) where excess water is boiled off. The concentrated CTP 420 catalyst suspension is returned to the BOP anolyte storage tank (not shown). CO₂ and excess water are eliminated and the remaining constituents are completely recycled.

A much faster chemical reaction rate can be achieved through the following alkali electrolyte chemistry:

2CH₃OH+12LiOH→2CO₂+10H₂O+12Li⁺+12e⁻(anode) Eq. (8)

3O₂+12Li⁺+12e⁺→6Li₂O(cathode intermediate) Eq. (9)

6Li₂O+6H₂O→12LiOH(cathode final) Eq. (10)

2CH₃OH+3O₂→2CO₂+4H₂O(overall) Eq. (11)

In this case excess water is produced in the anolyte and driven by controlled volumetric pressure across the spinning filter 140 along with Li⁺ anions into the catholyte. LiOH is filtered out of the catholyte and returned to the BOP anolyte tank (not shown) in a reverse direction from that described above for acid chemistry. Excess water is boiled off from the anolyte tank. Anolyte and catholyte catalyst suspensions are recirculated through their respective tanks and cell chambers.

The end result is the same as for acid chemistry. If LiOH is used exclusively as the alkali electrolyte, then the catalyzed cathode reaction of Eq. (9) will not suffer from suppressed water molecule dissociation in an excess of OH⁻ anion. The plentiful Li⁺ cation is a very effective proxy for the sparse H⁺ cation in alkali. Li₂O is completely soluble in water, as shown in Eq. (10), so the LiOH is fully recycled; first through the cell and subsequently through the BOP. Chemical kinetics dictates that all these reactions are very fast. Similar lithium-alkali chemistry was used to great advantage in the air-breathing metal battery shown in FIG. 3A.

The operation of the fuel cell 502 is similar to that of the metal-air flow cell 302 except as noted below. However, there are three principal differences between these two cells 302, 502.

A first principal difference between the fuel cell 502 and the flow cell 302 is that the fuel cell converts energy from a fuel into electricity; whereas, the flow cell 302 converts energy in a previously-charged CTP to electricity. The fuel may be any compound that is capable of being vaporized and creating protons (H⁺ ions) in anolyte during a redox reaction. Examples of suitable fuels include hydrogen, methane, methanol, ethanol, gasoline, kerosene, sodium borohydride and potassium borohydride. Depending on the choice of fuel and the operating temperature of the cell 502, the vaporization may take place in the inner electrolyte chamber 152 or in the BOP.

A second principal difference is the nature of particles suspended in the anolyte. In the flow battery 102 and the metal-air flow battery 302, the anolyte CTP 242 are faradaic and participate in a redox reaction to transform metals CTP into hydroxide particles, such as Fe into Fe(OH)₂ particles 254, and to release electrons 220. By contrast, the fuel cell 502 anolyte particles contain catalysts (e.g., Pt, Pd, Ni, Au, Ag, Cu or less expensive molecules previously cited) that do not participate in a redox reaction; but, promote oxidation of the fuel in order to release electrons. Catalyst suspensions are continuously recirculated through their respective fuel cell anolyte and catholyte chambers and through BOP tanks that are much smaller than those that would be required for faradaic suspensions.

A third principal difference is the nature of the chemical reactions. The flow batteries 102, 302 utilize two-phase redox reactions to transfer energy stored in the catholyte and anolyte into electrical energy used in external electrical circuits. The fuel cell 502 requires a three-phase reaction of fuel or oxygen, electrolyte and catalyst to generate electricity for the external electrical load. The collision of the catalyst CTP 420 (not shown in FIG. 5) in the anolyte with the current collector 106 porous metal wall 372A,B, 572 causes the catalyst CTP 420 to lose momentum and get drawn back into the anolyte TVF. The collision with the current collector porous metal wall 572 also causes the catalyst CTP to become coated with the electrolyte-fuel or electrolyte-oxygen solution and the presence of fuel, anolyte and catalyst initiates a three-phase redox reaction that charges the CTP 420. The CTP 420 has the benefit of a long interval as it returns to the center of the TVF many times where it regains sufficient momentum to escape. This interval is sufficient for the redox reaction to convert almost all of the chemical energy of the fuel coating the CTP 420 into electrical charge energy. Then, the next time that the CTP collides with the current collector, the electrons (e) 220 are transferred to the current collector for passage to the external electrical circuit. A complementary scenario occurs for the oxidizer reduction reaction (ORR) where O₂ is supplied through the oxygen port 374.

These structural and functional differences facilitate construction of TVF fuel cells 502 that provide superior performance and lower cost than prior art fuel cells. For example, conventional aqueous electrolyte fuel cells rely upon NAFION® ion-exchange membrane or similar materials to keep fuel and oxygen separated. Normal NAFION film will dehydrate and lose proton conductivity when its temperature exceeds approximately 80° C. This requires use of expensive platinum alloy catalyst that can be degraded by only partial oxidation of carbon in the fuel to CO. Some modifications to NAFION film will raise its maximum operating temperature to a range between 100° C. to 160° C.; but, platinum alloy catalyst is still required in that temperature range. The TVF fuel cell 502 does not contain any ion-exchange membrane or similar materials and therefore can run at temperatures in excess of 250° C., where inexpensive nickel, nickel-alloy and other low cost catalysts can be used for CTP in place of platinum.

The flow battery 102 of FIG. 1 requires approximately 6-times the volume of catholyte as the volume of anolyte. The same would be true for a fuel cell similar to the fuel cell 502 shown in FIG. 5 if it used the same catholyte. The fuel cell 502 uses O₂ and Mnₓ/C or other suitable catalyst CTP 380 instead of NiO(OH) CTP 216 in its positive catholyte outer chamber 158. For a large fuel cell 502, use of the VPSA oxygen generator is likely to be preferred because it is much smaller and lighter than any equivalent amount of catholyte.

The fuel cell 502 is operated to produce electricity for transmission to the external electrical circuit by a process comprising:
1. Filling the outer electrolyte chamber 158 with catholyte containing CTP 200 in suspension;
2. Filling the inner electrolyte chamber 156 with anolyte containing CTP 242 in suspension;
3. Pumping oxidizer through oxygen port 374 into the oxygen manifold 370 so that it penetrates the pores of the outer current collector 108;
4. Pumping vaporized fuel (in a gaseous state) through fuel port 574 into the fuel manifold 570 so that it penetrates the pores of the inner current collector 106 porous metal wall 572 to form menisci at the interface of the anolyte with the inner current collector 106; and
5. Rotating the spinning filter 140 at a rate of rotation adequate to cause—
   a. catholyte flows, such as TVF and CCF 154, to form in the outer electrolyte chamber 158 catholyte that accelerate the CTP 200 to collide with a current collector wall 372A,B; and
   b. anolyte flows, such as TVF CCF 152, to form in the inner electrolyte chamber 156 anolyte that accelerate the CTP 242 to collide with a current collector wall 572A,B

where the CTP 200,242 contain catalytic, in place of faradaic, materials.

Alternatively, the spinning filter 140 can be rotated at a speed that will not produce TVF or CCF; however, the fuel cell 502 will generate less electrical current.

In this embodiment, the catholyte flows in the outer electrolyte chamber 154, which is in the gap 130 between the spinning filter 140 and the outer current collector 108. The anolyte flows in an inner electrolyte chamber 152, which is in the gap 130 between the filter 140 and the inner current collectors 106. If another chemistry is selected, then the electrolyte chambers 152, 154 can be filled with anolyte and catholyte, respectively.

### SUMMar.Y

In a first embodiment, a galvanic electrochemical cell (100, 300, 500) for converting chemical energy into electrical energy for delivery to an electric circuit (210) comprising first and second cylinder-like current collectors (106A,B; 108A,B) having terminals (Ti_{1,2}, To_{1,2}) for electrical connection to the electric circuit (210) and separated from each other by a fluid electrolyte gap (130) between the current collectors; a cylinder-like spinning filter (140) in the gap (130) dividing the gap into an inner electrolyte chamber (156) and an outer electrolyte chamber (158); means (148, 150) for rotating the spinning filter (140) to create Taylor Vortex Flows (152, 154) in the chambers (156, 158) when the chambers (156, 158) contain the electrolyte; and means (266, BOP, 268) for creating convection gradients that flow the electrolyte from the first of the chambers (156, 158) to the second of the chambers (158, 156) in a first direction through the spinning filter (140).

In a second embodiment, the galvanic electrochemical cell wherein the means (BOP) for creating convection gradients that flow the electrolyte from the first of the chambers (156, 158) to the second of the chambers (158, 156) comprise in addition means (266, 268) for flowing the electrolyte in a second direction opposite the first direction and around the spinning filter (140).

In a third embodiment, the galvanic electrochemical cell comprising in addition fluid electrolyte in the inner chamber (156) and the outer chamber (158) of the gap (130); charge transfer particles of a first type (242) suspended in the electrolyte of the inner chamber (156); and charge transfer particles of a second type (202) suspended in the electrolyte of the outer chamber (158).

In a fourth embodiment, the galvanic electrochemical cell wherein one of the charge transfer particles (200, 242) comprises a faradaic material.

In a fifth embodiment, the galvanic electrochemical cell wherein one of the charge transfer particles (200, 242) comprises a catalytic material.

In a sixth embodiment, the galvanic electrochemical cell wherein some of the charge transfer particles (200, 242) have an enclosing sphere diameter of at least 30-microns.

In a seventh embodiment, the galvanic electrochemical cell wherein some of the charge transfer particles (200, 242) have an enclosing sphere diameter of not more than 75-microns.

In an eighth embodiment, the galvanic electrochemical cell wherein some of the charge transfer particles (200, 242) have an enclosing sphere diameter of at least 75-microns.

In a ninth embodiment, the galvanic electrochemical cell wherein some of the charge transfer particles (200, 242) have an enclosing sphere diameter of not more than 130-microns.

In a tenth embodiment, the galvanic electrochemical cell wherein some of the charge transfer particles (200, 242) have a mass of at least 0.5×10⁻⁶ grams.

In an eleventh embodiment, the galvanic electrochemical cell wherein the charge transfer particles (200) comprise NiO(OH).

In a twelfth embodiment, the galvanic electrochemical cell wherein the charge transfer particles (242) comprise Fe.

In a thirteenth embodiment, the galvanic electrochemical wherein the charge transfer particles (200, 242) comprise transition metals from Period 4 of the Period Table of the Elements.

In a fourteenth embodiment, the galvanic electrochemical cell wherein the charge transfer particles (200) comprise metals selected from a group consisting of Pt, Ir, Os, Pd, Rh, and Ru.

In a fifteenth embodiment, the galvanic electrochemical cell wherein the charge transfer particles (200) comprise powder of 1 to 5 microns in dimension attached onto metal substrates.

In a sixteenth embodiment, the galvanic electrochemical cell wherein the charge transfer particles (200, 242) comprise metals from a group consisting of Group 1 and Group 2 of the Period Table of the Elements.

In a seventeenth embodiment, the galvanic electrochemical cell wherein the charge transfer particles (200, 242) comprise metal hydrides.

In a nineteenth embodiment, the galvanic electrochemical cell wherein the electrolyte comprises an alkali fluid selected from a group consisting of KOH, LiOH, NaOH, Co(OH)₂, Zn(OH)₂, and Ca(OH).

In a twentieth embodiment, the galvanic electrochemical cell wherein the electrolyte comprises an acid fluid.

In a twenty-first embodiment, the galvanic electrochemical cell wherein the electrolyte comprises an acid fluid selected from a group consisting of HCl, H₂SO₄, H₃PO₄, HNO₃, H₂CrO₄ and H₃BO₃.

In a twenty-second embodiment, the galvanic electrochemical cell wherein the electrolyte comprises an organic fluid.

In a twenty-third embodiment, the galvanic electrochemical cell wherein the electrolyte comprises an organic fluid selected from a group consisting of ethylene carbonate, diethyl carbonate, ethers and esters.

In a twenty-fourth embodiment, the galvanic electrochemical cell configured as a battery.

In a twenty-fifth embodiment, the galvanic electrochemical cell configured as a flow cell.

In a twenty-sixth embodiment, the galvanic electrochemical cell configured as a fuel cell.

In a twenty-seventh embodiment, the galvanic electrochemical cell configured as a flow battery and comprising in addition an air catholyte.

In a twenty-eighth embodiment, the galvanic electrochemical cell configured as a fuel cell and comprising in addition an air catholyte.

In a twenty-ninth embodiment, the galvanic electrochemical cell wherein the electrolyte concentration is 10-molar.

In a thirtieth embodiment, the galvanic electrochemical cell comprising in addition an oxygen manifold (370) with a porous wall (372A,B) opening into the fluid electrolyte gap (130) and secured to one of the current collectors (106A,B; 108A,B); and a port (374) connected at one end to the oxygen manifold (370) and open at the other end for receiving oxygen from an external source.

In a thirty-first embodiment, the galvanic electrochemical cell wherein the charge transfer particles (156, 158) comprise catalytic nanoparticles (386) of doped Me-MnOₓ, where Me is a material selected from a group consisting of Ni and Mg

In a thirty-second embodiment, the galvanic electrochemical cell wherein the charge transfer particles (156, 158) comprise a steel core and a sheath of porous carbon (384) encasing the steel core (382) to which the catalytic particles (386) are attached.

In a thirty-third embodiment, the galvanic electrochemical cell wherein the catalytic nanoparticles (386) are deposited on a carbon-coated electrolyte-facing surface of one of the current collector (308A,B) porous walls (372A,B).

In a thirty-fourth embodiment, the galvanic electrochemical cell configured as a fuel cell and comprising in addition a fuel manifold (570) with a porous wall (572A,B) opening into the fluid electrolyte gap (130) and secured to one of the current collectors (106A,B; 108A,B); and a port (574) connected at one end to the oxygen manifold (570) and open at the other end for receiving fuel from an external source.

In a thirty-fifth embodiment, the galvanic electrochemical cell configured as a fuel cell and wherein the fuel contains a chemical selected from a group consisting of hydrogen, methane, methanol, ethanol, gasoline, kerosene, sodium borohydride and potassium borohydride.

In a thirty-sixth embodiment, the galvanic electrochemical cell wherein the charge transfer particles (156, 158) comprise hammers that are galvanically-inert materials working in combination with supplementary galvanic particles lacking an attribute selected from a group consisting of sufficient mass and sufficient size to be charge transfer particles.

In a thirty-seventh embodiment, the galvanic electrochemical cell wherein the hammers of the charge transfer particles (156, 158) comprise hydrophilic particles that are combined with the supplementary particles that can be charged by galvanic reactions.

In a thirty-eighth embodiment, the galvanic electrochemical cell wherein the hammers of the charge transfer particles (156, 158) comprise porous metal containing the supplementary particles.

In a thirty-ninth embodiment, the galvanic electrochemical cell wherein the charge transfer particles (156, 158) comprise a coating of graphene.

In a fortieth embodiment, the galvanic electrochemical cell wherein the volumetric particle concentration of the charge transfer particles (156, 158) in the electrolyte is in a range between 40% to 75%, inclusive.

In a forty-first embodiment, the galvanic electrochemical cell wherein the electrolyte comprises a suspension of charge transfer particles that is a thixotropic fluid.

In a first process of this invention for operating a galvanic electrochemical cell as a flow battery (302) to produce electricity for transmission to an electrical circuit (210) comprising filling the outer electrolyte chamber 158 with catholyte containing charge transfer particles 200 in suspension; filling the inner electrolyte chamber 156 with anolyte containing charge transfer particles 242 in suspension; pumping oxidizer through oxygen port 374 into the oxygen manifold 370 so that it penetrates the pores of the outer current collector 108; and rotating the spinning filter 140 at a rate of rotation adequate to cause—catholyte flows, such as Taylor Vortex Flows and Circular Couette Flows 154, to form in the outer electrolyte chamber 158 catholyte that accelerate the charge transfer particles 200 to collide with a current collector wall 372A,B; and anolyte flows, such as Taylor Vortex Flows and Circular Couette Flows 152, to form in the inner electrolyte chamber 156 anolyte that accelerate the charge transfer particles 242 to collide with a current collector wall 106A,B where the charge transfer particles 200,242 contain faradaic materials.

In a second process of this invention for operating a galvanic electrochemical cell as a fuel cell (502) to produce electricity for transmission to an electrical circuit (210) comprising filling the outer electrolyte chamber 158 with catholyte containing charge transfer particles 200 in suspension; filling the inner electrolyte chamber 156 with anolyte containing charge transfer particles 242 in suspension; pumping oxidizer through oxygen port 374 into the oxygen manifold 370 so that it penetrates the pores of the outer current collector 108; pumping fuel through fuel port 574 into the fuel manifold 570 so that it penetrates the pores of the inner current collector 106 porous metal wall 572 to form menisci at the interface of the anolyte with the inner current collector 106; and rotating the spinning filter 140 at a rate of rotation adequate to cause—catholyte flows, such as Taylor Vortex Flows and Circular Couette Flows 154, to form in the outer electrolyte chamber 158 catholyte that accelerate the charge transfer particles 200 to collide with a current collector wall 372A,B; and anolyte flows, such as Taylor Vortex Flows and Circular Couette Flows 152, to form in the inner electrolyte chamber 156 anolyte that accelerate the charge transfer particles 242 to collide with a current collector wall 572A,B where the charge transfer particles 200,242 contain catalytic materials.

### CONCLUSION

This invention discloses dynamic accelerated reaction galvanic electrochemistry. The galvanic cells 100, 300, 500 of this invention offer structures that provide improved fluid dynamics (e.g., TVF, CCF) for use with flowable electrolyte suspensions that contain galvanic charge transfer particles acting as electrodes in coordination with current collectors that need not contain galvanic materials. Unlike prior art fuel cells where galvanic particles are sparsely secured in fixed positions to electrodes and difficult to replace, the charge transfer particles in the galvanic cells of this invention are plentiful and can be easily replaced by simply replacing the electrolyte suspension. These differences—amongst others such as provision for providing catholyte and anolyte convection flows in opposing directions—provide more economical galvanic cells with higher current densities.

All patents and patent applications identified in this disclosure are hereby incorporated herein by reference.

While the present disclosure has been presented above with respect to the described and illustrated embodiments using TVF and CCF, it is to be understood that the disclosure is not to be limited to those alternatives and described embodiments. Accordingly, reference should be made primarily to the following claims to determine the scope of my invention.

1. A galvanic electrochemical cell (100, 300, 500) for converting chemical energy into electrical energy for delivery to an electric circuit (210) comprising:
a) first and second cylinder-like current collectors (106A,B; 108A,B) having terminals (Tit,2, To1,2) for electrical connection to the electric circuit (210) and separated from each other by a fluid electrolyte gap (130) between the current collectors;
b) a cylinder-like spinning filter (140) in the gap (130) dividing the gap into an inner electrolyte chamber (156) and an outer electrolyte chamber (158);
c) means (148, 150) for rotating the spinning filter (140) to create Taylor Vortex Flows (152, 154) in the inner electrolyte chamber (156) and the outer electrolyte chambers (158) when the inner electrolyte chamber (156) and the outer electrolyte chamber (158) contain an electrolyte; and
d) means (266, BOP, 268) for creating convection gradients that flow the electrolyte from one of the inner electrolyte chamber (156) and the outer electrolyte chamber (158) to the other of the inner electrolyte chamber (156) and the outer electrolyte chamber (158) in a first direction through the spinning filter (140).

2. The galvanic electrochemical cell (100, 300, 500) of claim 1 wherein the means (BOP) for creating convection gradients that flow the electrolyte from one of the inner electrolyte chamber (156) and the outer electrolyte chamber (158) to the other of the inner electrolyte chamber (156) and the outer electrolyte chamber (158) comprise in addition:
means (266, 268) for flowing the electrolyte in a second direction opposite the first direction and around the spinning filter (140).

3. The galvanic electrochemical cell (100, 300, 500) of claim 1 comprising in addition:
a) fluid electrolyte in the inner chamber (156) and the outer chamber (158) of the gap (130);
b) charge transfer particles of a first type (242) suspended in the electrolyte of the inner chamber (156); and
c) charge transfer particles of a second type (202) suspended in the electrolyte of the outer chamber (158).

4. The galvanic electrochemical cell (100, 300, 500) of claim 3 wherein one of the charge transfer particles (200, 242) comprises:
a faradaic material.

5. The galvanic electrochemical cell (100, 300, 500) of claim 3 wherein one of the charge transfer particles (200, 242) comprises:
a catalytic material.

6. The galvanic electrochemical cell (100, 300, 500) of claim 3 wherein some of the charge transfer particles (200, 242) have an enclosing sphere diameter of:
at least 30-microns.

7. The galvanic electrochemical cell (100, 300, 500) of claim 6 wherein some of the charge transfer particles (200, 242) have an enclosing sphere diameter of:
not more than 75-microns.

8. The galvanic electrochemical cell (100, 300, 500) of claim 3 wherein some of the charge transfer particles (200, 242) have an enclosing sphere diameter of:
at least 75-microns.

9. The galvanic electrochemical cell (100, 300, 500) of claim 8 wherein some of the charge transfer particles (200, 242) have an enclosing sphere diameter of:
not more than 130-microns.

10. The galvanic electrochemical cell (100, 300, 500) of claim 3 wherein some of the charge transfer particles (200, 242) have a mass of:
at least 0.5×10⁻⁶ grams.

11. The galvanic electrochemical cell (100, 300, 500) of claim 4 wherein the charge transfer particles (200) comprise:
NiO(OH).

12. The galvanic electrochemical cell (100, 300, 500) of claim 4 wherein the charge transfer particles (242) comprise:
Fe.

13. The galvanic electrochemical cell (100, 300, 500) of claim 4 wherein the charge transfer particles (200, 242) comprise:
transition metals from Period 4 of the Period Table of the Elements.

14. The galvanic electrochemical cell (100, 300, 500) of claim 13 wherein the charge transfer particles (200) comprise:
metals selected from a group consisting of Pt, Ir, Os, Pd, Rh, and Ru.

15. The galvanic electrochemical cell (100, 300, 500) of claim 13 wherein the charge transfer particles (200) comprise:
powder of 1 to 5 microns in dimension attached onto metal substrates.

16. The galvanic electrochemical cell (100, 300, 500) of claim 4 wherein the charge transfer particles (200, 242) comprise:
metals from a group consisting of Group 1 and Group 2 of the Period Table of the Elements.

17. The galvanic electrochemical cell (100, 300, 500) of claim 4 wherein the charge transfer particles (200, 242) comprise:
metal hydrides.

18. The galvanic electrochemical cell (100, 300, 500) of claim 3 wherein the electrolyte comprises:
an alkali fluid.

19. The galvanic electrochemical cell (100, 300, 500) of claim 18 wherein the electrolyte comprises:
an alkali fluid selected from a group consisting of KOH, LiOH, NaOH, Co(OH)₂, Zn(OH)₂, and Ca(OH).

20. The galvanic electrochemical cell (100, 300, 500) of claim 3 wherein the electrolyte comprises:
an acid fluid.

21. The galvanic electrochemical cell (100, 300, 500) of claim 20 wherein the electrolyte comprises:
an acid fluid selected from a group consisting of HCl, H₂SO₄, H₃PO₄, HNO₃, H₂CrO₄ and H₃BO₃.

22. The galvanic electrochemical cell (100, 300, 500) of claim 3 wherein the electrolyte comprises:
an organic fluid.

23. The galvanic electrochemical cell (100, 300, 500) of claim 22 wherein the electrolyte comprises:
an organic fluid selected from a group consisting of ethylene carbonate, diethyl carbonate, ethers and esters.

24. The galvanic electrochemical cell (100, 300, 500) of claim 1 configured as a:
battery.

25. The galvanic electrochemical cell (100, 300, 500) of claim 1 configured as a:
flow battery.

26. The galvanic electrochemical cell (100, 300, 500) of claim 1 configured as a:
fuel cell.

27. The galvanic electrochemical cell (100, 300, 500) of claim 25 comprising in addition an:
air catholyte.

28. The galvanic electrochemical cell (100, 300, 500) of claim 26 comprising in addition a:
air catholyte.

29. The galvanic electrochemical cell (100, 300, 500) of claim 3 wherein the electrolyte concentration is:
10-molar.

30. The galvanic electrochemical cell (100, 300, 500) of claim 3 comprising in addition:
a) an oxygen manifold (370) with a porous wall (372A,B) opening into the fluid electrolyte gap (130) and secured to one of the current collectors (106A,B; 108A,B); and
b) a port (374) connected at one end to the oxygen manifold (370) and open at the other end for receiving oxygen from an external source.

31. The galvanic electrochemical cell (100, 300, 500) of claim 30 wherein the charge transfer particles (156, 158) comprise:
catalytic nanoparticles (386) of doped Me-MnOₓ, where Me is a material selected from a group consisting of Ni and Mg.

32. The galvanic electrochemical cell (100, 300, 500) of claim 31 wherein the charge transfer particles (156, 158) comprise:
a) a steel core (382); and
b) a sheath of porous carbon (384) encasing the steel core (382) to which the catalytic particles (386) are attached.

33. The galvanic electrochemical cell (100, 300, 500) of claim 31 wherein the catalytic nanoparticles (386) are deposited on:
a carbon-coated electrolyte-facing surface of one of the current collector (308A,B) porous walls (372A,B).

34. The galvanic electrochemical cell (100, 300, 500) of claim 3 configured as a fuel cell (500) and comprising in addition:
a) a fuel manifold (570) with a porous wall (572A,B) opening into the fluid electrolyte gap (130) and secured to one of the current collectors (106A,B;108A,B); and
b) a port (574) connected at one end to the oxygen manifold (570) and open at the other end for receiving fuel from an external source.

35. The galvanic electrochemical cell (100, 300, 500) of claim 32 wherein:
the fuel contains a chemical selected from a group consisting of hydrogen, methane, methanol, ethanol, gasoline, kerosene, sodium borohydride and potassium borohydride.

36. The galvanic electrochemical cell (100, 300, 500) of claim 3 wherein the charge transfer particles (156, 158) comprise:
hammers that are galvanically-inert materials working in combination with supplementary galvanic particles lacking an attribute selected from a group consisting of sufficient mass and sufficient size to be charge transfer particles.

37. The galvanic electrochemical cell (100, 300, 500) of claim 36 wherein the hammers of the charge transfer particles (156, 158) comprise:
hydrophilic particles that are combined with the supplementary particles that can be charged by galvanic reactions.

38. The galvanic electrochemical cell (100, 300, 500) of claim 37 wherein the hammers of the charge transfer particles (156, 158) comprise:
porous metal containing the supplementary particles.

39. The galvanic electrochemical cell (100, 300, 500) of claim 3 wherein the charge transfer particles (156, 158) comprise:
a coating of a graphene.

40. The galvanic electrochemical cell (100, 300, 500) of claim 3 wherein the volumetric particle concentration of the charge transfer particles (156, 158) in the electrolyte is in a range between:
40% to 75%, inclusive.

41. The galvanic electrochemical cell (100, 300, 500) of claim 3 wherein the electrolyte comprises:
a suspension of charge transfer particles (156, 158) that is a thixotropic fluid.

42. A process for operating a flow battery (302) to produce electricity for transmission to an electrical circuit (210) comprising:
a) filling the outer electrolyte chamber 158 with catholyte containing charge transfer particles 200 in suspension;
b) filling the inner electrolyte chamber 156 with anolyte containing the charge transfer particles 242 in suspension;
c) pumping oxidizer through oxygen port 374 into the oxygen manifold 370 so that it penetrates the pores of the outer current collector 108; and
d) rotating the spinning filter 140 at a rate of rotation adequate to cause
i. catholyte flows comprising Taylor Vortex Flows and Circular Couette Flows 154, to form in the outer electrolyte chamber 158 catholyte that accelerate the charge transfer particles 200 to collide with a current collector wall 372A,B; and
ii. anolyte flows comprising Taylor Vortex Flows and Circular Couette Flows 152, to form in the inner electrolyte chamber 156 anolyte that accelerate the charge transfer particles 242 to collide with a current collector wall106A,B
where the charge transfer particles 200,242 contain faradaic materials.

43. A process for operating a fuel cell (502) to produce electricity for transmission to an electrical circuit (210) comprising:
a) filling the outer electrolyte chamber 158 with catholyte containing charge transfer particles 200 in suspension;
b) filling the inner electrolyte chamber 156 with anolyte containing charge transfer particles 242 in suspension;
c) pumping oxidizer through oxygen port 374 into the oxygen manifold 370 so that it penetrates the pores of the outer current collector 108;
d) pumping fuel through fuel port 574 into the fuel manifold 570 so that it penetrates the pores of the inner current collector 106 porous metal wall 572 to form menisci at the interface of the anolyte with the inner current collector 106; and
e) rotating the spinning filter 140 at a rate of rotation adequate to cause
i. catholyte flows comprising Taylor Vortex Flows and Circular Couette Flows 154, to form in the outer electrolyte chamber 158 catholyte that accelerate the charge transfer particles 200 to collide with a current collector wall 372A,B; and
ii. anolyte flows comprising Taylor Vortex Flows and Circular Couette Flows 152, to form in the inner electrolyte chamber 156 anolyte that accelerate the charge transfer particles 242 to collide with a current collector wall 572A,B
where the charge transfer particles 200,242 contain catalytic materials.
